(19) United States
(12) Patent Application Publication
(10) Pub. No.: US 2024/0092487 A1
(43) Pub. Date: Mar. 21, 2024

(54) UNMANNED AERIAL VEHICLE, UNMANNED AERIAL VEHICLE MOUNTING METHOD, AND UNMANNED AERIAL VEHICLE CENTER OF GRAVITY ADJUSTMENT METHOD

(71) Applicant: DAIWA KASEI INDUSTRY CO.,LTD., Okazaki-shi (JP)

(72) Inventors: Haruhisa KAMIYA, Okazaki-shi (JP); Toshio IWAHARA, Okazaki-shi (JP)

(21) Appl. No.: 18/297,108

(22) Filed: Apr. 7, 2023

(30) Foreign Application Priority Data
Apr. 12, 2022 (JP) 2022-065477

(51) Int. Cl. B64D 9/00; B60L 50/60; B64U 40/20; B64U 50/10; H01M 50/249; H01M 50/271

(52) U.S. Cl. CPC B64D 9/00; B60L 50/60; B64U 40/20; B64U 50/10; H01M 50/249; H01M 50/271; B64U 2101/64

(57) ABSTRACT

Provided are an unmanned aerial vehicle and a method that enable mounting work for a package and a battery to be efficiently performed. The unmanned aerial vehicle includes a package-chamber tray, a package-chamber cover attached to the package-chamber tray from above, a battery provided on an upper surface of the package-chamber cover, and a body capable of flying, the body being attachable and detachable to and from a package chamber formed by the package-chamber tray and the package-chamber cover. First, packages are placed on the package-chamber tray. Next, the package-chamber cover is attached to the package-chamber tray. Next, the battery is placed on the package-chamber cover. At this time, the mounting position of the battery is adjusted in accordance with the center of gravity position of the entirety of the packages. Then, the body is attached to the package chamber.

### REFERENCE TO RELATED APPLICATION

This application claims priority on Japanese Patent Application No. 2022-65477 filed on Apr. 12, 2022, the entire contents of which are incorporated herein by reference.

### BACKGROUND OF THE INVENTION

### Field of the Invention

This disclosure relates to an unmanned aerial vehicle for package transportation.

### DESCRIPTION OF RELATED ART

Conventionally, it has been proposed that a package is transported using an unmanned aerial vehicle (also called a drone) (see, for example, Japanese Laid-Open Patent Publication No. 2021-8270, WO2020/136742, and Japanese Patent No. 6357602). For example, Japanese Laid-Open Patent Publication No. 2021-8270 proposes technology of moving a battery in a direction at a predetermined angle during flight, to improve flight efficiency of an aerial vehicle to which a package is mounted. WO2020/136742 proposes a package receiving and storing apparatus and a method for receiving and storing a package delivered by an unmanned aerial vehicle. Japanese Patent No. 6357602 proposes technology in which a battery to be mounted is selected on the basis of location information about a delivery destination of a package, weight information of the package, center of gravity information when a package is placed at the unmanned aerial vehicle, and the like.

In a case of transporting a package by an unmanned aerial vehicle, it is desirable that mounting work for a package and a battery to the unmanned aerial vehicle can be efficiently performed. Needless to say, flight of the unmanned aerial vehicle needs to be stabilized.

Accordingly, a first object of this disclosure is to provide an unmanned aerial vehicle and a method that enable mounting work for a package and a battery to be efficiently performed. A second object of this disclosure is to provide a method that enables flight of an unmanned aerial vehicle to be stabilized.

### SUMMARY OF THE INVENTION

An unmanned aerial vehicle of this disclosure includes: a placement portion on which a package is to be placed; a package-chamber cover which is attached to the placement portion so as to cover the package placed on the placement portion and is provided separably from the placement portion; a battery provided on an upper surface of the package-chamber cover and configured to drive an unmanned aerial vehicle; and a body capable of flying, the body being attachable and detachable to and from a package chamber formed by including the placement portion and the package-chamber cover.

Accordingly, since the placement portion for the package is separable from the package-chamber cover, the package can be placed on the placement portion in a state in which the placement portion is separated from the package-chamber cover. Then, in a state in which the package is placed on the placement portion, the package-chamber cover is attached to the placement portion, thus obtaining a state in which the package is mounted in the package chamber formed by the placement portion and the package-chamber cover. In addition, since the package chamber is separable from the body, mounting work for the package into the package chamber can be performed in a state in which the package chamber is separated from the body. In addition, the battery can be mounted on the upper surface of the package chamber in the state in which the package chamber is separated from the body. Thus, before the package chamber is attached to the body, the package chamber with the package and the battery mounted thereto can be prepared in advance (can be initially set up). Then, the package chamber with the package and the battery mounted thereto is attached to the body of the unmanned aerial vehicle, whereby the package and the battery can be mounted to the body at the same time. Thus, mounting work for the package and the battery to the unmanned aerial vehicle (body) can be efficiently performed. In addition, since initial setup for the package chamber can be performed, it is possible to select a sufficiently charged battery needed for performing flight with the package to the destination and having a minimum necessary capacity (weight). Thus, the battery can be prevented from being charged or replaced with another battery during transportation of the package. In addition, since the battery having a minimum necessary capacity (weight) can be selected, the weight of the unmanned aerial vehicle can be reduced, whereby fuel efficiency (power consumption of battery) during flight can be reduced. Thus, the flight distance can be efficiently increased.

An unmanned aerial vehicle mounting method of this disclosure is a method for mounting a package to the unmanned aerial vehicle of this disclosure, the method including: a package mounting step of placing the package on the placement portion; a first integration step of integrating the package-chamber cover and the placement portion on which the package is placed, after the package mounting step; a battery mounting step of placing the battery on the upper surface of the package chamber in which the package is housed, after the first integration step; and a second integration step of integrating the body and the package chamber in which the package is housed and on the upper surface of which the battery is placed, after the battery mounting step.

Accordingly, since the package is placed on the placement portion in a state in which the placement portion for the package is separated from the package-chamber cover and the body, mounting work for the package can be facilitated. In addition, since the battery is mounted on the upper surface of the package chamber in a state in which the package chamber is separated from the body, mounting work for the battery can be facilitated. In addition, before the package chamber is attached to the body, the package chamber with the package and the battery mounted thereto can be prepared in advance (can be initially set up). Then, in the second integration step, the package chamber with the package and the battery mounted thereto is integrated with the body of the unmanned aerial vehicle, whereby the package and the battery can be mounted to the body at the same time. Thus, mounting work for the package and the battery to the unmanned aerial vehicle (body) can be efficiently performed. In addition, since initial setup for the package chamber can be performed, it is possible to select a sufficiently charged battery needed for performing flight with the package to the destination and having a minimum necessary capacity (weight). Thus, the battery can be prevented from being charged or replaced with another battery during transportation of the package. In addition, since the battery having a minimum necessary capacity (weight) can be selected, the weight of the unmanned aerial vehicle can be reduced, whereby fuel efficiency during flight can be reduced. Thus, the flight distance can be efficiently increased.

An unmanned aerial vehicle center of gravity adjustment method of this disclosure is a method for adjusting a center of gravity position of the unmanned aerial vehicle of this disclosure, the method comprising adjusting, before flight of the unmanned aerial vehicle, a mounting position of the battery on the upper surface of the package chamber, a mounting position of the package on the placement portion, or a mounting position, in the body, of the package chamber at which the battery is placed.

Accordingly, flight of the unmanned aerial vehicle can be stabilized. In addition, the mounting position of the battery or the package can be adjusted in initial setup in a state in which the package chamber is separated from the body. Then, when the package chamber with the mounting position of the battery or the package adjusted is integrated with the body, the center of gravity position of the entire unmanned aerial vehicle is automatically determined. Thus, since the mounting position of the battery or the package can be adjusted in initial setup, the center of gravity position of the entire unmanned aerial vehicle can be determined in initial setup.

### BRIEF DESCRIPTION OF THE DRAWINGS

FIG. 1 is a top view of an unmanned aerial vehicle in first to third embodiments as seen from above;

FIG. 2 is a sectional view of the unmanned aerial vehicle along line II-II in FIG. 1;

FIG. 3 is a sectional view of the unmanned aerial vehicle along line in FIG. 1;

FIG. 4 is an exploded perspective view of the unmanned aerial vehicle in the first to third embodiments;

FIG. 5 is a sectional view of the unmanned aerial vehicle along line V-V in FIG. 1;

FIG. 6 is a bottom view of a package-chamber cover as seen from below;

FIG. 7 is a bottom view of a body of the unmanned aerial vehicle as seen from below;

FIG. 8 shows a base for the unmanned aerial vehicle;

FIG. 9 is a block diagram showing an electric configuration provided to the base;

FIG. 10 shows package-chamber sequential assembly on a package-chamber sequential-assembly line provided to the base;

FIG. 11 is a flowchart showing a procedure for mounting a package and a battery to the unmanned aerial vehicle in the first to third embodiments;

FIG. 12 is a flowchart showing the details of step S4 in FIG. 11 in the first embodiment;

FIG. 13 shows an adjustment example of a battery-mounting position in a package chamber;

FIG. 14 shows another example, different from FIG. 13, of adjustment of the battery-mounting position in the package chamber;

FIG. 15 is a flowchart showing a procedure for separating parts of the unmanned aerial vehicle;

FIG. 16 is a flowchart showing the details of step S4 in FIG. 11 in the second embodiment;

FIG. 17 is a flowchart showing the details of step S2 in FIG. 11 in the third embodiment;

FIG. 18 is a sectional view of the unmanned aerial vehicle in a fourth embodiment;

FIG. 19 is a perspective view of a package-chamber cover, a battery tray, a battery, and parts (body-side connector, attachment portion) of a body cover in the fourth embodiment;

FIG. 20 is a flowchart showing a procedure for mounting a package and the battery to the unmanned aerial vehicle in the fourth embodiment;

FIG. 21 shows a first modification of a package-chamber cover and is a perspective view of the package-chamber cover having an opening with a lower end cut out, at a side-surface portion; and

FIG. 22 shows a second modification of a package-chamber cover and is a perspective view of the package-chamber cover having an opening with a lower end closed, at a side-surface portion.

### DETAILED DESCRIPTION

### First Embodiment

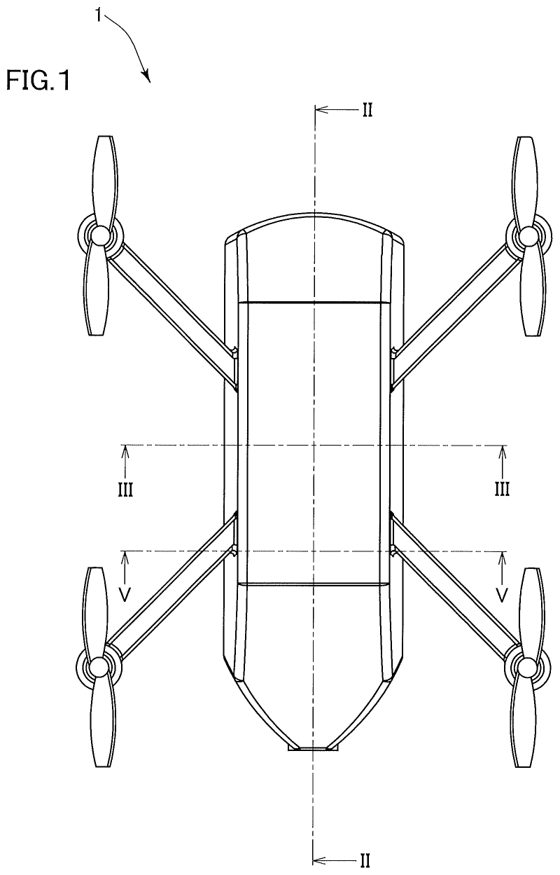

Hereinafter, a first embodiment of this disclosure will be described with reference to the drawings. FIGS. 1 to 4 show an unmanned aerial vehicle 1 (drone) for package transportation in the first embodiment. The unmanned aerial vehicle 1 (hereinafter, may be simply referred to as aerial vehicle) shown in FIGS. 1 to 4 includes a package-chamber tray 2, a package-chamber cover 3, a battery 4, and a body 5.

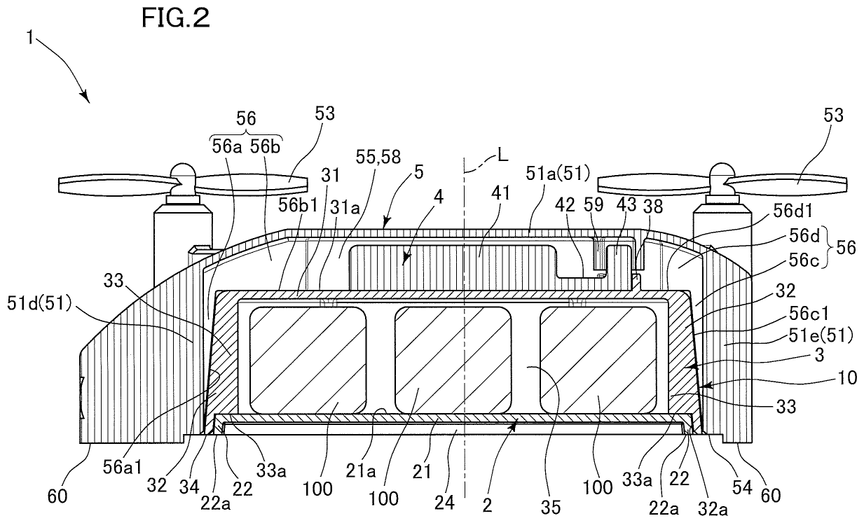

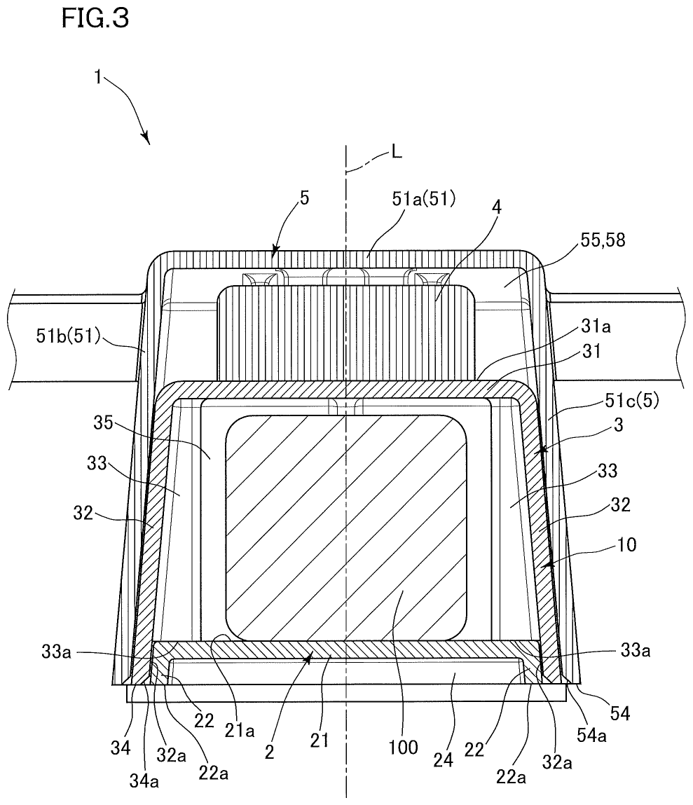

The package-chamber tray 2 is a placement portion on which a package 100 (see FIGS. 2 to 4) is to be placed. The package-chamber tray 2 includes a tray body 21 forming a placement surface 21a (see FIGS. 2 and 3) for the package 100, and an outer-periphery portion 22 located around an outer periphery of the tray body 21. The tray body 21 is formed in a flat-plate shape, for example. An upper surface 21a of the tray body 21 is set as a placement surface for the package 100. The placement surface 21a is formed as a horizontal surface. In this embodiment, a plan-view shape of the placement surface 21a is a rectangle of which a length in the front-rear direction (advancement direction) (direction perpendicular to drawing sheet in FIG. 3) of the aerial vehicle 1 is greater than a length in the left-right direction (left-right direction on drawing sheet in FIG. 3). The placement surface 21a may be formed in a shape other than a rectangle. The placement surface 21a has a size that allows a plurality of (for example, three) packages 100 to be placed thereon.

The outer-periphery portion 22 is provided over the entire outer periphery of the tray body 21 so as to protrude downward from the tray body 21. In a case where the plan-view shape of the tray body 21 is a rectangle, the outer-periphery portion 22 is provided at each of four sides forming the rectangle. The outer-periphery portion 22 is formed in a slightly sloped shape so as to be gradually displaced outward (a direction away from a package-chamber centerline L shown in FIGS. 2 and 3) as approaching the lower side from the tray body 21. The package-chamber centerline L is a line passing the center of the placement surface 21a and perpendicular to the placement surface 21a. Since the outer-periphery portion 22 is formed in a slightly sloped shape, the package-chamber tray 2 can be easily inserted (attached) into a space 35 in the package-chamber cover 3. By the tray body 21 and the outer-periphery portion 22, a space 24 (see FIGS. 2 and 3) opened on the lower side and closed on the sides (upper side and lateral sides) other than the lower side is formed under the tray body 21.

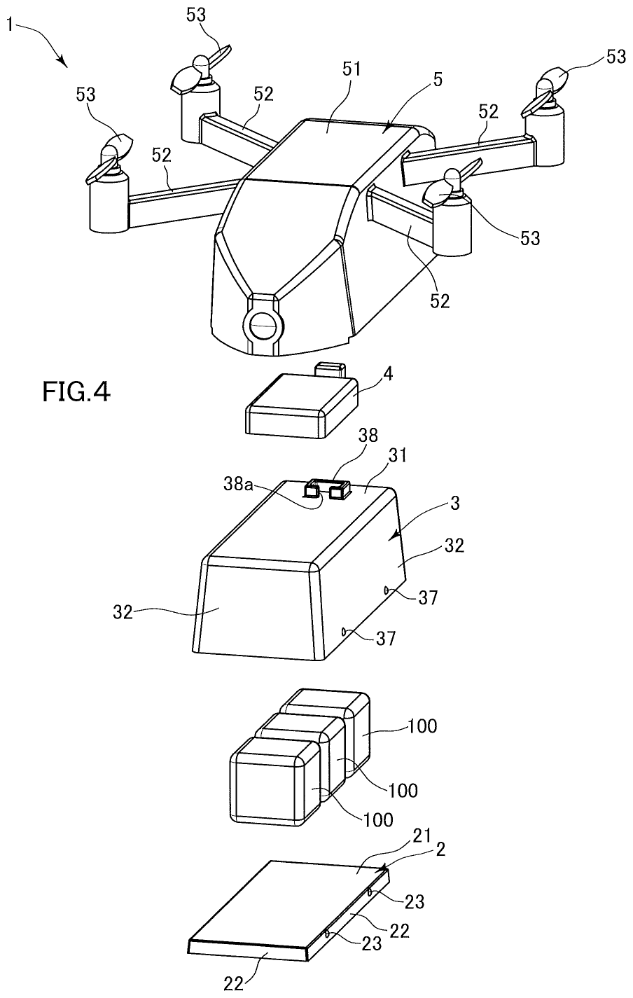

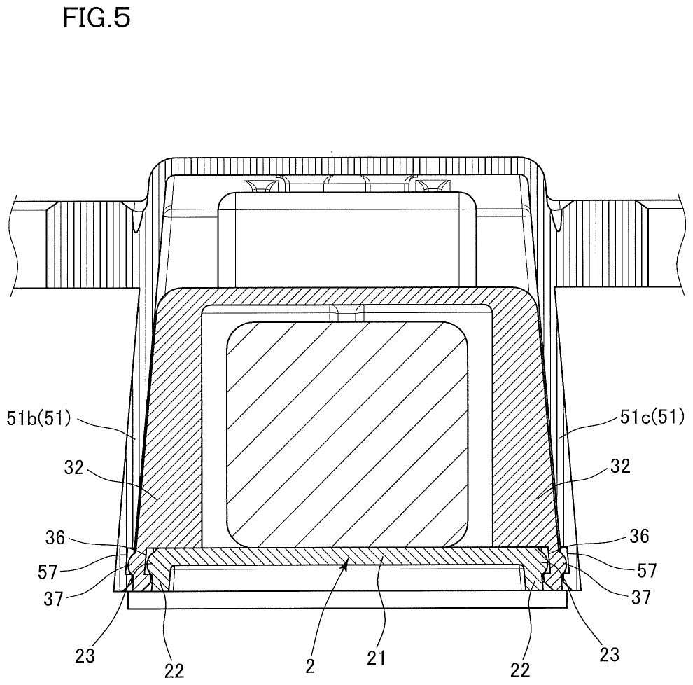

The package-chamber tray 2 is provided so as to be attachable and detachable to and from the package-chamber cover 3. Specifically, the package-chamber tray 2 is attached to the package-chamber cover 3 from below the package-chamber cover 3, and is provided so as to be detachable downward from the package-chamber cover 3. More specifically, as shown in FIGS. 4 and 5, the package-chamber tray 2 includes attachment portions 23 to be attached to the package-chamber cover 3. The attachment portions 23 are provided at the outer surface of the outer-periphery portion 22, for example. The attachment portions 23 are provided at a plurality of positions along the peripheral direction around the package-chamber tray 2. In this embodiment, two attachment portions 23 are provided on each of two sides extending in the front-rear direction (advancement direction) of the aerial vehicle 1, among the outer-periphery portions 22 forming the four sides of the rectangle (see FIG. 4). However, the attachment portions 23 may be provided on sides extending in the left-right direction, among the outer-periphery portions 22 forming the four sides of the rectangle. The number of the attachment portions 23 may be any number.

Each attachment portion 23 is formed in a shape to be engaged (i.e., fitted) with an attachment portion 36 (see FIG. 5) on the package-chamber cover 3 side. Specifically, the attachment portion 23 is formed in a protrusion shape (projection shape), for example, and the attachment portion 36 on the package-chamber cover 3 side is formed in a groove shape (recess shape). In a state in which the package-chamber tray 2 is attached to the package-chamber cover 3, the protrusion-shaped attachment portion 23 is fitted to the groove-shaped attachment portion 36. The attachment portions 23, 36 are configured to keep the engagement state between the attachment portions 23, 36 unless a predetermined release operation is performed. In addition, the attachment portions 23, 36 are configured such that the engagement state between the attachment portions 23, 36 is released when the predetermined release operation is performed. For example, the engagement force (engagement amount between protrusion and groove) between the attachment portions 23, 36 is set such that engagement between the attachment portions 23, 36 is released when an operation of pulling the package-chamber cover 3 upward is performed with the package-chamber tray 2 held so as not to move upward or when an operation of pulling the package-chamber tray 2 downward is performed with the package-chamber cover 3 held so as not to move downward. Alternatively, the protrusion of the attachment portion 23 may be configured to be movable so as to retract mechanically or electrically. In this case, when the protrusion of the attachment portion 23 is retracted, engagement between the attachment portions 23, 36 is released.

The attachment portion 23 on the package-chamber tray 2 side may be formed in a groove shape and the attachment portion 36 on the package-chamber cover 3 side may be formed in a protrusion shape. The engagement configuration between the attachment portions 23, 36 may be other than fitting between a projection and a recess, and for example, may be a bolt-latch type. In a case where the attachment portions 23, 36 are configured as a bolt-latch type, the attachment portions 23, 36 are formed by including a through-hole formed on the package-chamber tray 2 side, a through-hole formed on the package-chamber cover 3 side, and a bolt member to be inserted into the two through-holes aligned with each other. When the bolt member is inserted into the two through-holes, the package-chamber tray 2 and the package-chamber cover 3 come into an attached state, and when insertion of the bolt member into the two through-holes is released, the package-chamber tray 2 and the package-chamber cover 3 are separated.

As shown in FIGS. 2 and 3, the package-chamber tray 2 is attached to the package-chamber cover 3 so as to close a downward opening 34 of the package-chamber space 35 in the package-chamber cover 3. In a state in which the package-chamber tray 2 is attached to the package-chamber cover 3, the tray body 21 is located on the inner side of the package-chamber space 35 relative to the downward opening 34 of the package-chamber cover 3. In addition, the entire periphery of an outer surface of the outer-periphery portion 22 contacts with (is positioned by) an inner surface 32a of a side-surface portion 32 of the package-chamber cover 3, whereby movement of the package-chamber tray 2 in the horizontal direction relative to the package-chamber cover 3 is restricted. In addition, parts of an outer-periphery portion of the upper surface of the tray body 21 contact with (are positioned by) lower ends 33a of inner protruding portions 33 provided to the package-chamber cover 3, whereby upward movement of the package-chamber tray 2 relative to the package-chamber cover 3 is restricted. Meanwhile, downward movement of the package-chamber tray 2 relative to the package-chamber cover 3 is restricted by the attachment portions 23, 36. In the state in which the package-chamber tray 2 is attached to the package-chamber cover 3, a lower end 22a of the outer-periphery portion 22 is located at substantially the same up-down-direction position as a lower end 34 (downward opening) of the package-chamber cover 3.

The package-chamber cover 3 is attachable and detachable to and from the package-chamber tray 2. Specifically, the package-chamber cover 3 is attached to the package-chamber tray 2 from above the package-chamber tray 2 so as to cover the package 100 placed on the package-chamber tray 2. The package-chamber cover 3 is provided so as to be detachable (separable) upward of the package-chamber tray 2.

Specifically, the package-chamber cover 3 is formed in a substantially rectangular parallelepiped shape, for example, but may be formed in a shape other than a substantially rectangular parallelepiped shape. The package-chamber cover 3 includes an upper-surface portion 31 and the side-surface portion 32. The upper-surface portion 31 and the side-surface portion 32 form the package-chamber space 35 having an opening 34 on the lower side and closed on all the sides (lateral sides and upper side) other than the lower side. Thus, the package-chamber cover 3 is formed in a box shape opened on the lower side, in a state in which the package-chamber tray 2 is separated. When the package-chamber tray 2 is attached to the package-chamber cover 3, the opening 34 of the package-chamber space 35 is closed by the package-chamber tray 2, so that all the sides (including lower side) of the package-chamber space 35 are closed. In the closed package-chamber space 35, the package 100 placed on the package-chamber tray 2 is housed. The package-chamber space 35 has a size that allows a plurality of packages 100 to be housed therein. In FIG. 2, three packages 100 are housed in the package-chamber space 35 so as to be arranged in the front-rear direction of the package-chamber space 35, as an example. However, the number of the packages 100 may be any number, and the arrangement direction of the packages 100 may be any of horizontal directions (e.g., left-right direction).

The upper-surface portion 31 is formed in, for example, a rectangular flat-plate shape of which a length in the front-rear direction (advancement direction) of the aerial vehicle 1 is greater than a length in the left-right direction, in a plan view. However, without limitation thereto, the upper-surface portion 31 may be formed in any shape such as a square (a rectangle having equal lengths in the left-right direction and the front-rear direction), a rectangle of which a length in the left-right direction is greater than a length in the front-rear direction, or an ellipse. An outer surface 31a (upper surface) of the upper-surface portion 31 is formed as a horizontal surface. The outer surface 31a is formed as a battery-placement surface (i.e., battery-mounting portion) on which the battery 4 is placed. The outer surface 31a is formed as a battery-mounting portion that allows the mounting position of the battery 4 to be adjusted at the time of placing the battery 4 on the outer surface 31a.

On the outer surface 31a, a connector holder 38 for holding a connector 43 of the battery 4 so that the connector 43 does not move is provided integrally with the outer surface 31a (see FIGS. 2 and 4). The connector holder 38 is formed in a shape protruding upward from the outer surface 31a and surrounding the periphery of the connector 43. The connector holder 38 has a linking portion 38a through which the inner side (housing space for connector 43) and the outer side of the connector holder 38 (see FIG. 4) communicate with each other. A wire 42 of the battery 4 passes through the linking portion 38a. The connector holder 38 is provided at a position opposed to a connector 59 provided to the body 5 in a state in which the package-chamber cover 3 is attached to the body 5 (see FIG. 2). That is, the connector holder 38 is provided at such a position that the connector 43 of the battery 4 and the connector 59 of the body 5 are connected when a package chamber 10 (package-chamber tray 2 and package-chamber cover 3) with the battery 4 mounted thereto is attached to the body 5.

The side-surface portion 32 of the package-chamber cover 3 is formed in a plate shape extending downward from the entire outer periphery of the upper-surface portion 31. The side-surface portion 32 includes a front-surface portion facing in the advancement direction of the aerial vehicle 1, a rear-surface portion facing in the rearward direction opposite to the advancement direction, a left-surface portion facing in the leftward direction with respect to the advancement direction, and a right-surface portion facing in the rightward direction with respect to the advancement direction. The side-surface portion 32 is formed in a slightly sloped shape so as to be gradually displaced outward (a direction away from the package-chamber centerline L shown in FIGS. 2 and 3) as approaching the lower side from the upper-surface portion 31. Since the side-surface portion 32 is formed in a slightly sloped shape as described above, the package-chamber cover 3 can be easily inserted (attached) into a space 55 in a body cover 51 described later. A slope angle of the side-surface portion 32 with respect to the package-chamber centerline L is the same as a slope angle of the outer-periphery portion 22 of the package-chamber tray 2 with respect to the package-chamber centerline L. Thus, when the package-chamber tray 2 is attached to the package-chamber cover 3, the outer surface of the outer-periphery portion 22 and the inner surface of the side-surface portion 32 can closely contact with each other. However, the slope angle of the side-surface portion 32 and the slope angle of the outer-periphery portion 22 may be different from each other.

The lower end 34 of the side-surface portion 32 forms an opening having the same shape as the plan-view shape of the package-chamber tray 2, as seen in a plan view. The inner-edge side of the lower end 34 is formed in such a taper shape 34a that the width of the opening 34 is gradually reduced as approaching the upper side (see FIG. 3). The taper shape 34a is formed over the entire periphery of the opening 34. Owing to the taper shape 34a, the package-chamber tray 2 can be easily put inside the opening 34 at the time of attaching the package-chamber tray 2 to the package-chamber cover 3.

At the inner surface 32a of the side-surface portion 32, the inner protruding portions 33 protruding inward (package-chamber centerline L side) are formed (see FIGS. 2, 3, and 6). As shown in FIG. 6, a plurality of the inner protruding portions 33 are arranged with an interval therebetween along the periphery direction of the side-surface portion 32. Specifically, one inner protruding portion 33 is provided to each of the front-surface portion and the rear-surface portion among the side-surface portions 32 on the front, rear, left, and right sides, and two inner protruding portions 33 are provided to each of the left-surface portion and the right-surface portion. The inner protruding portions 33 provided to the front-surface portion and the rear-surface portion are located at the centers of the widths in the left-right direction of the front-surface portion and the rear-surface portion.

As shown in FIGS. 2 and 3, each inner protruding portion 33 has a lower end 33a at a position distant upward from the lower end 34 (opening) of the side-surface portion 32 and extends from the lower end 33a to the position of the upper-surface portion 31. That is, an upper end of the inner protruding portion 33 is connected to the upper-surface portion 31. The lower end 33a of the inner protruding portion 33 is formed to represent a horizontal line as seen in the directions of FIGS. 2 and 3. As described above, the lower end 33a and the upper surface 21a of the package-chamber tray 2 contact with each other. In FIGS. 2 and 3, the package-chamber tray 2 is positioned in the up-down direction by ribs (inner protruding portions 33) protruding from the inner surface of the side-surface portion 32 of the package-chamber cover 3, as an example. However, the positioning may be made by means other than ribs. For example, the side-surface portion 32 of the package-chamber cover 3 may be formed to have such a protruding sectional shape that the remaining part other than the lower part of the side-surface portion 32 where the package-chamber tray 2 is located protrudes inward, similarly to FIG. 2, as seen in a cross-section along any of front-rear-direction lines parallel to a front-rear-direction centerline (line in FIG. 1 or a cross-section along any of left-right-direction lines parallel to a left-right-direction centerline (line III-III) in FIG. 1.

As described above, the package-chamber cover 3 is attachable and detachable to and from the package-chamber tray 2. Specifically, the package-chamber cover 3 has, at the inner surface 32a of the side-surface portion 32, the attachment portions 36 having shapes engageable with the attachment portions 23 on the package-chamber tray 2 side (see FIG. 5). As described above, each attachment portion 36 is formed in a groove shape (recess shape) to be fitted to the protrusion-shaped attachment portion 23, for example. The attachment portion 36 is provided at a position lower than the lower end 33a of the inner protruding portion 33, on the inner surface 32a. The attachment portions 36 are provided at a plurality of positions along the periphery direction of the package-chamber cover 3 so as to correspond to the positions of the attachment portions 23 on the package-chamber tray 2 side.

The package-chamber cover 3 is attachable and detachable to and from the body 5. Specifically, as shown in FIGS. 4 and 5, the package-chamber cover 3 includes attachment portions 37 to be attached to the body 5. The attachment portions 37 are provided at an outer surface of the side-surface portion 32, for example. The attachment portions 37 are provided at a plurality of positions along the periphery direction of the package-chamber cover 3. In this embodiment, two attachment portions 37 are provided to each of the left-surface portion and the right-surface portion, among the side-surface portions 32 on the front, rear, left, and right sides (see FIG. 4). However, the attachment portions 37 may be provided to the front-surface portion and the rear-surface portion, among the side-surface portions 32 on the front, rear, left, and right sides. The number of the attachment portions 37 may be any number.

Each attachment portion 37 is formed in a shape to be engaged (i.e., fitted) with an attachment portion 57 (see FIG. 5) on the body 5 side. Specifically, the attachment portion 37 is formed in a protrusion shape (projection shape), for example, and the attachment portion 57 on the body 5 side is formed in a groove shape (recess shape). In a state in which the package-chamber cover 3 is attached to the body 5, the protrusion-shaped attachment portion 37 is fitted to the groove-shaped attachment portion 57. The attachment portions 37, 57 are configured to keep the engagement state between the attachment portions 37, 57 unless a predetermined release operation is performed. In addition, the attachment portions 37, 57 are configured such that the engagement state between the attachment portions 37, 57 is released when the predetermined release operation is performed. For example, the engagement force (engagement amount between protrusion and groove) between the attachment portions 37, 57 is set such that engagement between the attachment portions 37, 57 is released when an operation of pulling the body 5 upward is performed with the package-chamber cover 3 held so as not to move upward or when an operation of pulling the package-chamber cover 3 downward is performed with the body 5 held so as not to move downward. Alternatively, the protrusion of the attachment portion 37 may be configured to be movable so as to retract mechanically or electrically. In this case, when the protrusion of the attachment portion 37 is retracted, engagement between the attachment portions 37, 57 is released.

The attachment portion 37 on the package-chamber cover 3 side may be formed in a groove shape and the attachment portion 57 on the body 5 may be formed in a protrusion shape. The engagement configuration between the attachment portions 37, 57 may be other than fitting between a projection and a recess, and for example, may be a bolt-latch type. In a case where the attachment portions 37, 57 are configured as a bolt-latch type, the attachment portions 37, 57 are formed by including a through-hole formed on the package-chamber cover 3 side, a through-hole formed on the body 5 side, and a bolt member to be inserted into the two through-holes aligned with each other. When the bolt member is inserted into the two through-holes, the package-chamber cover 3 and the body 5 come into an attached state, and when insertion of the bolt member into the two through-holes is released, the package-chamber cover 3 and the body 5 are separated.

By the package-chamber tray 2 and the package-chamber cover 3 being integrated, the package chamber 10 is formed. The package chamber 10 is attachable and detachable to and from the body 5 (specifically, body cover 51 described later). Specifically, the package chamber 10 is attached to the body 5 from below the body 5, and is provided so as to be detachable downward from the body 5. As shown in FIGS. 2 and 3, the package chamber 10 is attached to the body 5 so as to be housed in the body space 55 formed in the body 5. In this embodiment, in a state in which the package chamber 10 is attached to the body 5, the entire package chamber 10 is housed in the body space 55. However, a part on the lower-end side of the package chamber 10 may be exposed to the outside of the body space 55. In a state in which the package chamber 10 is attached to the body 5, a lower end (lower end 34 of package-chamber cover 3 or lower end 22a of package-chamber tray 2) of the package chamber 10 may be located at the same up-down-direction position as a downward opening 54 of the body space 55, may be located on the inner side of the body space 55 relative to the downward opening 54, or may be located at a position exposed to the outside from the downward opening 54.

In a state in which the package chamber 10 is attached to the body 5, the downward opening 54 of the body space 55 is closed by the package chamber 10. Further, in the state in which the package chamber 10 is attached to the body 5, the entire outer surfaces of the side-surface portions 32 on the left and right sides of the package-chamber cover 3 contact with (are positioned by) wall surfaces of the body space 55, whereby leftward/rightward movement of the package chamber 10 relative to the body 5 is restricted (see FIG. 3). In addition, in the state in which the package chamber 10 is attached to the body 5, parts of the outer surfaces of the side-surface portions 32 on the front and rear sides of the package-chamber cover 3 contact with (are positioned by) inner protruding portions 56 provided in the body space 55, whereby frontward/rearward movement of the package chamber 10 relative to the body 5 is restricted (see FIG. 2). In addition, in the state in which the package chamber 10 is attached to the body 5, parts of the outer surface 31a of the upper-surface portion 31 of the package-chamber cover 3 contact with (are positioned by) the inner protruding portions 56, whereby upward movement of the package chamber 10 relative to the body 5 is restricted (see FIG. 2). Downward movement of the package chamber 10 relative to the body 5 is restricted by the attachment portions 37, 57. As described above, in this embodiment, there is no space for adjusting the position of the package chamber 10, in the body space 55.

As described above, the battery 4 is mounted on the upper-surface portion 31 of the package-chamber cover 3. The battery 4 is housed in a battery-housing space 58 formed by the upper surface 31a of the package chamber 10 (package-chamber cover 3) and a wall surface of the body space 55 (see FIGS. 2 and 3). The battery 4 is a battery for driving the aerial vehicle 1, and more specifically, a battery for supplying power to a driving portion for a rotary blade 53 as a lift-generation portion provided to the body 5. The battery 4 is a rechargeable secondary battery. As the battery 4, various secondary batteries are applicable. For example, a nickel hydrogen battery, a lithium polymer battery, a lithium ion battery, or a lithium ferrite battery may be used.

As shown in FIG. 2, the battery 4 includes a battery body 41, the wire 42, and the connector 43. The battery body 41 supplies power to the outside via the wire 42 and the connector 43. The battery body 41 is mounted with spaces (spaces allowing position adjustment) provided in horizontal directions (front-rear direction and left-right direction) in the battery-housing space 58. The battery body 41 is mounted in a state in which upward/downward movement thereof is restricted by the upper-surface portion 31 of the package-chamber cover 3 and the upper surface of the body space 55.

The wire 42 connects the battery body 41 and the connector 43. The length of the wire 42 includes an extra length so as to allow the battery body 41 to be mounted at any position in the horizontal direction in the battery-housing space 58. The connector 43 is held by the aforementioned connector holder 38 so as not to move. The connector 43 is connected to the connector 59 on the body 5 side. The connector 43 and the connector 59 are attachable and detachable to and from each other. In this disclosure, the connector 43 corresponds to a first connector and the connector 59 corresponds to a second connector. The connector holder 38 corresponds to a holding portion.

At the time of attaching the battery 4 onto the package-chamber cover 3 (at the time of mounting the battery 4 to the aerial vehicle 1), the position of the battery body 41 can be adjusted in the horizontal direction in the battery-housing space 58. Meanwhile, it is undesirable that the mounting position of the battery body 41 unintentionally changes during flight of the aerial vehicle 1. Therefore, in order to prevent the battery body 41 from moving on the upper surface 31a of the package-chamber cover 3 during flight, the battery body 41 may be fixed to the upper surface 31a by simple means such as a hook-and-loop fastener.

The rotary blade 53 as a lift-generation portion and a thrust-generation portion is connected to the body 5. That is, the body 5 is configured to be able to fly. As shown in FIG. 4, the body 5 includes the body cover 51, an arm 52 connected to the body cover 51, and the rotary blade 53 (propeller) connected to an end of the arm 52. The arm 52 is provided so as to protrude laterally from the body cover 51, for example. A plurality of the arms 52 and a plurality of rotary blades 53 (in the example in FIG. 4, four of each) may be provided.

Further, the body 5 includes a driving portion (motor) for driving the rotary blades 53, a communication portion, a sensor portion, a recording portion, and a control portion (not shown). The communication portion is a part for communicating with an external management device (not shown) during flight, and for example, transmits a detected value (e.g., present-location information) of the sensor portion to the management device or receives a flight-control signal from the management device. The sensor portion may include various sensors, e.g., a camera, GPS sensor, an acceleration sensor, a gyro sensor, an infrared sensor, a voice sensor, a brightness sensor, a wind-direction/wind-speed sensor, a geomagnetic sensor, an altitude sensor, a displacement sensor, a temperature sensor, a heat sensor, or a pressure sensor. The recording portion records therein various data needed for transportation of the package 100. The recording portion may record therein transportation-destination information of the package 100 so that autonomous flight can be performed when communication with the external management device is impossible. The control portion controls driving of the rotary blades 53 on the basis of the detected value of the sensor portion, the flight-control signal received by the communication portion, and the like.

The body cover 51 is formed in a box shape (i.e., substantially rectangular parallelepiped shape) having the opening 54 on the lower side. Specifically, the body cover 51 is formed in a shape having an upper-surface portion 51a, left and right side-surface portions 51b, 51c, a front-surface portion 51d, and a rear-surface portion 51e. Inside these surface portions 51a to 51e, the body space 55 having the opening 54 on the lower side and closed on the sides (left, right, front, rear, and upper sides) other than the lower side is formed. The opening 54 is formed in the same shape as the plan-view shape of the package chamber 10, as seen in a plan view. The body space 55 is a space for housing the package chamber 10 and the battery 4 mounted therein. Of the body space 55, the space 58 surrounded by the upper surface 31a of the package chamber 10 and the upper-surface portion 51a of the body cover 51 is set as the aforementioned battery-housing space.

The inner-edge side of the part forming the opening 54 of the body cover 51 is formed in such a taper shape 54a that the width of the opening 54 is gradually reduced as approaching the upper side (see FIG. 3). The taper shape 54a is formed over the entire periphery of the opening 54. Owing to the taper shape 54a, the package chamber 10 can be easily put into the body space 55 at the time of attaching the package chamber 10 to the body cover 51.

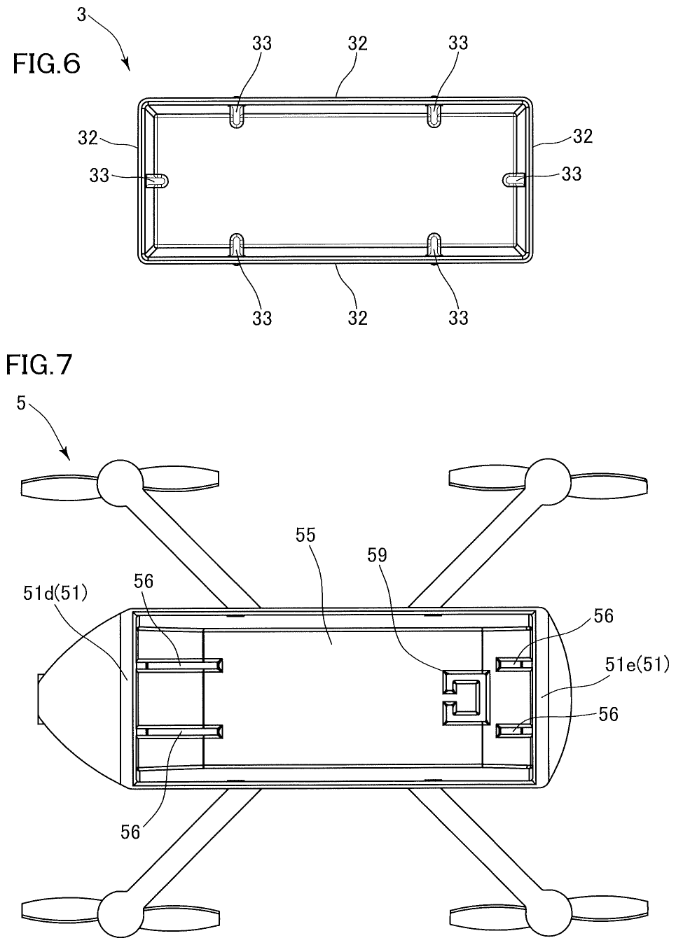

The inner protruding portions 56 protruding toward the inside of the body space 55 are formed at wall surfaces of the body space 55 (see FIGS. 2 and 7). The inner protruding portions 56 are formed at four locations in total, i.e., two locations on the front side and two locations on the rear side in the front-rear direction (see FIG. 7). Specifically, as shown in FIG. 2, each inner protruding portion 56 located at the front of the package-chamber cover 3 includes a first protruding portion 56a protruding rearward from an inner surface (a surface facing the body space 55) of the front-surface portion 51d, and a second protruding portion 56b protruding downward from an inner surface (a surface facing the body space 55) of the upper-surface portion 51a. The first protruding portion 56a and the second protruding portion 56b are continuously formed. The first protruding portion 56a is formed continuously from the position of the opening 54 of the body space 55 to the position of the upper-surface portion 51a (second protruding portion 56b). The first protruding portion 56a is formed in such a shape that the rearward protruding amount thereof gradually increases as approaching the upper side. That is, a rearward protruding end 56a1 of the first protruding portion 56a is formed in a sloped shape so as to be gradually displaced rearward as approaching the upper side. A slope angle of the protruding end 56a1 with respect to the package-chamber centerline L (vertical direction) is the same as the slope angle of the front-surface portion of the package-chamber cover 3 with respect to the package-chamber centerline L. That is, in a state in which the package-chamber cover 3 is attached to the body cover 51, the entire protruding end 56a1 contacts with the front-surface portion of the package-chamber cover 3.

The second protruding portion 56b is formed to protrude downward from a front-side part of the upper-surface portion 51a. A downward protruding end 56b1 of the second protruding portion 56b is formed in parallel to a horizontal plane, i.e., formed to represent a horizontal line as seen in the direction of FIG. 2. That is, in a state in which the package-chamber cover 3 is attached to the body cover 51, the entire protruding end 56b1 contacts with the upper surface 31a of the package-chamber cover 3.

As shown in FIG. 2, the inner protruding portion 56 located at the rear of the package-chamber cover 3 includes a third protruding portion 56c protruding frontward from an inner surface (a surface facing the body space 55) of the rear-surface portion 51e and a fourth protruding portion 56d protruding downward from an inner surface (a surface facing the body space 55) of the upper-surface portion 51a. The third protruding portion 56c and the fourth protruding portion 56d are continuously formed. The third protruding portion 56c is formed in such a shape that the frontward protruding amount thereof gradually increases as approaching the upper side. That is, a frontward protruding end 56c1 of the third protruding portion 56c is formed in a sloped shape so as to be gradually displaced frontward as approaching the upper side. A slope angle of the protruding end 56c1 with respect to the package-chamber centerline L is the same as the slope angle of the rear-surface portion of the package-chamber cover 3 with respect to the package-chamber centerline L. That is, in a state in which the package-chamber cover 3 is attached to the body cover 51, the entire protruding end 56c1 contacts with the rear-surface portion of the package-chamber cover 3.

The fourth protruding portion 56d is formed to protrude downward from a rear-side part of the upper-surface portion 51a. A downward protruding end 56d1 of the fourth protruding portion 56d is formed in parallel to a horizontal plane, i.e., formed to represent a horizontal line as seen in the direction of FIG. 2. That is, in a state in which the package-chamber cover 3 is attached to the body cover 51, the entire protruding end 56d1 contacts with the upper surface 31a of the package-chamber cover 3.

Thus, frontward/rearward movement and upward movement of the package chamber 10 relative to the body cover 51 are restricted by the four inner protruding portions 56. The inner protruding portions 56 serve as positioning portions that determine the position of the package chamber 10 in the body space 55, i.e., serve as movement-restricting portions that restrict movement of the package chamber 10 relative to the body cover 51. Leftward/rightward movement of the package chamber 10 is restricted by the left and right side-surface portions 51b, 51c of the body cover 51 (see FIG. 3). As described above, downward movement of the package chamber 10 is restricted by the attachment portions 37, 57.

Lower surfaces 60 (see FIG. 2) of the body cover 51 are located at the front and the rear of the opening 54, and are provided so as to be stepped downward from the opening 54. The lower surfaces 60 are formed as horizontal surfaces. The lower surfaces 60 serve as contact surfaces contacting with the ground in a state in which the aerial vehicle 1 is landed. The lower end of the package chamber 10 (lower end 22a of package-chamber cover 2 and lower end 34 of package-chamber cover 3) is located at a position higher than the lower surfaces 60. That is, in a state in which the package chamber 10 is attached to the body cover 51, the lower ends 22a, 34 of the package chamber 10 are slightly spaced from the ground.

The body cover 51 is attachable and detachable to and from the package chamber 10 (package-chamber cover 3). Specifically, the body cover 51 is attached to the package chamber 10 from above the package chamber 10, and is provided so as to be detachable upward from the package chamber 10. More specifically, the body cover 51 has, at the inner surfaces of the left and right side-surface portions 51b, 51c, the attachment portions 57 having shapes engageable with the attachment portions 37 on the package-chamber cover 3 side (see FIG. 5). As described above, each attachment portion 57 is formed in a groove shape (recess shape) to be fitted to the protrusion-shaped attachment portion 37, for example. The attachment portions 57 are provided at a plurality of positions along the periphery direction of the body cover 51 so as to correspond to the positions of the attachment portions 37 on the package-chamber cover 3 side.

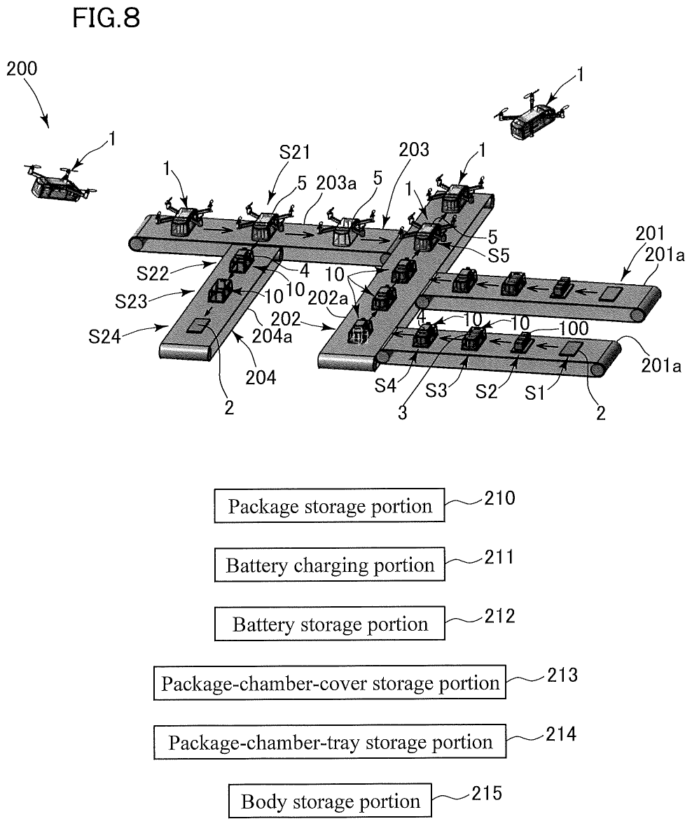

The aerial vehicle 1 is used in a distribution system for sequentially performing transportation of products (packages), for example. FIG. 8 exemplifies a base 200, for the aerial vehicle 1, which constitutes a distribution system using the aerial vehicle 1. The base 200 forms a mounting system, for the aerial vehicle 1, which mounts the package chamber 10 at which the package 100 and the battery 4 are placed, to the body 5. In addition, the base 200 forms a separation system, for the aerial vehicle 1, which takes down the package chamber 10 and the battery 4 from the aerial vehicle 1 having returned after finishing transportation of the package 100 and separates the aerial vehicle 1 into the parts 2, 3, 4, 5.

The base 200 is a departure base for the aerial vehicle 1 with the package 100 mounted thereto and is also a base to which the aerial vehicle 1 having finished transportation of the package 100 returns. Specifically, the base 200 includes a package-chamber sequential-assembly line 201, a shipping line 202, a body line 203, and a package-chamber retrieval line 204. The package-chamber sequential-assembly line 201 is a line for assembling the package chamber 10 with the package 100 and the battery 4 mounted thereto. The package-chamber sequential-assembly line 201 includes a conveyance portion 201a, such as a conveyor belt, of which the conveyance direction is perpendicular to the conveyance direction of the shipping line 202, for example. The package-chamber sequential-assembly line 201 may include a plurality of conveyance portions 201a arranged in parallel to each other, for example. Each conveyance portion 201a is driven to perform conveyance to the shipping line 202.

The shipping line 202 is a line for receiving the package chamber 10 which has been conveyed from the package-chamber sequential-assembly line 201 and to which the package 100 and the battery 4 are mounted, and then conveying the package chamber 10. In addition, the shipping line 202 is a line for receiving the body 5 conveyed from the body line 203, and then integrating the body 5 and the package chamber 10 being conveyed, into the aerial vehicle 1. Further, the shipping line 202 is a line from which the aerial vehicle 1 with the package 100 mounted thereto departs. The shipping line 202 includes a conveyance portion 202a for conveying the package chamber 10 received from the package-chamber sequential-assembly line 201, in a direction perpendicular to the conveyance direction of the package-chamber sequential-assembly line 201.

The body line 203 is a line for receiving the returned aerial vehicle 1, detaching the package chamber 10 at which the battery 4 is placed from the body 5 of the aerial vehicle 1, and conveying the body 5 to the shipping line 202. The body line 203 includes a conveyance portion 203a for performing conveyance to the shipping line 202. The conveyance direction of the conveyance portion 203a is perpendicular to the conveyance direction of the shipping line 202, for example.

The package-chamber retrieval line 204 is a line for retrieving the package chamber 10 which has been detached from the body 5 of the returned aerial vehicle 1 and to which the battery 4 is mounted. More specifically, the package-chamber retrieval line 204 is a line for separating the package chamber 10 with the battery 4 mounted thereto, into the parts 2, 3, 4, and retrieving the parts 2, 3, 4. The package-chamber retrieval line 204 includes a conveyance portion 204a of which the conveyance direction is perpendicular to the conveyance direction of the body line 203.

The base 200 includes, in addition to the lines 201 to 204, a package storage portion 210, a battery charging portion 211, a battery storage portion 212, a package-chamber-cover storage portion 213, a package-chamber-tray storage portion 214, and a body storage portion 215 (see FIG. 8). The package storage portion 210 is a part (place) where the package 100 planned to be transported is stored. The battery charging portion 211 is a part for charging the battery 4. The battery 4 is sufficiently charged (e.g., fully charged) by the battery charging portion 211, for example.

The battery storage portion 212 is a part (place) where the charged battery 4 or the battery 4 before charging is stored. In the battery storage portion 212, plural kinds of batteries 4 having different capacities (weights) are stored, i.e., the battery 4 having a large capacity, the battery 4 having a middle capacity, and the battery 4 having a small capacity, are stored. The package-chamber-cover storage portion 213 is a part (place) where the package-chamber cover 3 is stored. The package-chamber-tray storage portion 214 is a part (place) where the package-chamber tray 2 is stored. The body storage portion 215 is a part (place) where the body 5 is stored.

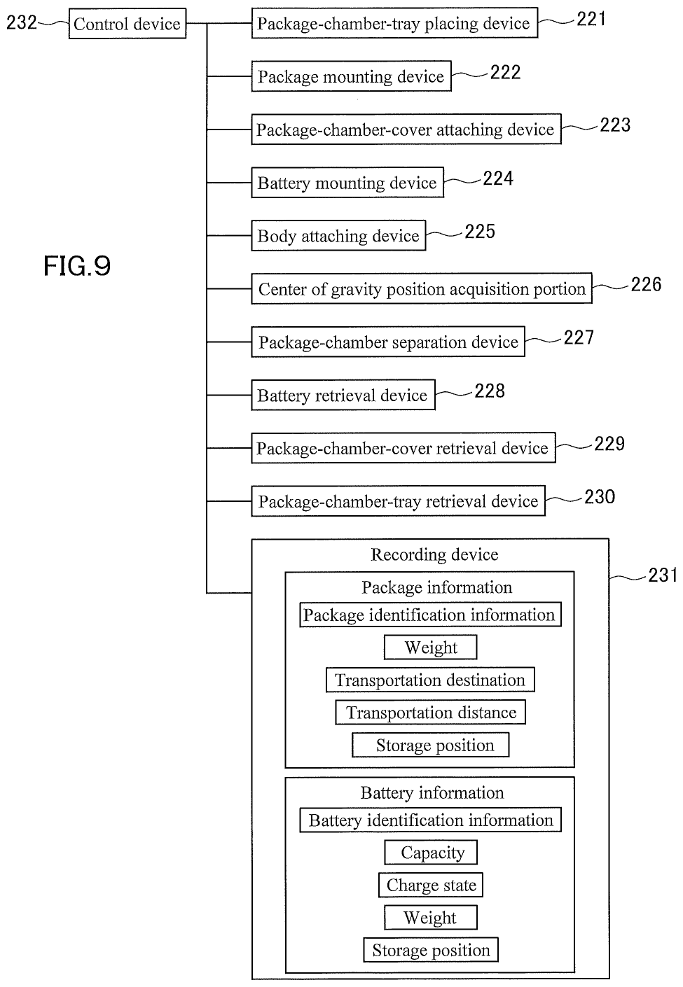

In addition, the base 200 has an electric configuration shown in FIG. 9. Specifically, the base 200 includes a package-chamber-tray placing device 221, a package mounting device 222, a package-chamber-cover attaching device 223, a battery mounting device 224, a body attaching device 225, and a center of gravity position acquisition portion 226. Further, the base 200 includes a package-chamber separation device 227, a battery retrieval device 228, a package-chamber-cover retrieval device 229, a package-chamber-tray retrieval device 230, a recording device 231, and a control device 232.

The package-chamber-tray placing device 221 is provided on an upstream side of the package-chamber sequential-assembly line 201. The package-chamber-tray placing device 221 is a device (robot) for grasping the package-chamber tray 2 stored in the package-chamber-tray storage portion 214, and then placing the package-chamber tray 2 on the conveyance portion 201a of the package-chamber sequential-assembly line 201.

The package mounting device 222 is provided on a downstream side of the package-chamber sequential-assembly line 201 relative to the package-chamber-tray placing device 221. The package mounting device 222 is a device (robot) for grasping the package 100 stored in the package storage portion 210, and then placing the package 100 on the package-chamber tray 2 conveyed by the conveyance portion 201a.

The package-chamber-cover attaching device 223 is provided on a downstream side of the package-chamber sequential-assembly line 201 relative to the package mounting device 222. The package-chamber-cover attaching device 223 is a device (robot) for grasping the package-chamber cover 3 stored in the package-chamber-cover storage portion 213, and then attaching the package-chamber cover 3 to the package-chamber tray 2 which is conveyed by the conveyance portion 201a and on which the package 100 is placed.

The battery mounting device 224 is provided on a downstream side of the package-chamber sequential-assembly line 201 relative to the package-chamber-cover attaching device 223. The battery mounting device 224 is a device (robot) for grasping the battery 4 stored in the battery storage portion 212, and then placing the battery 4 on the upper surface of the package chamber 10 (package-chamber cover 3) conveyed by the conveyance portion 201a.

The body attaching device 225 is provided at a location where the shipping line 202 and the body line 203 merge. The body attaching device 225 is a device (robot) for grasping the body 5 conveyed by the body line 203, and then attaching the body 5 to the package chamber 10 which is conveyed by the shipping line 202 and to which the package 100 and the battery 4 are mounted.

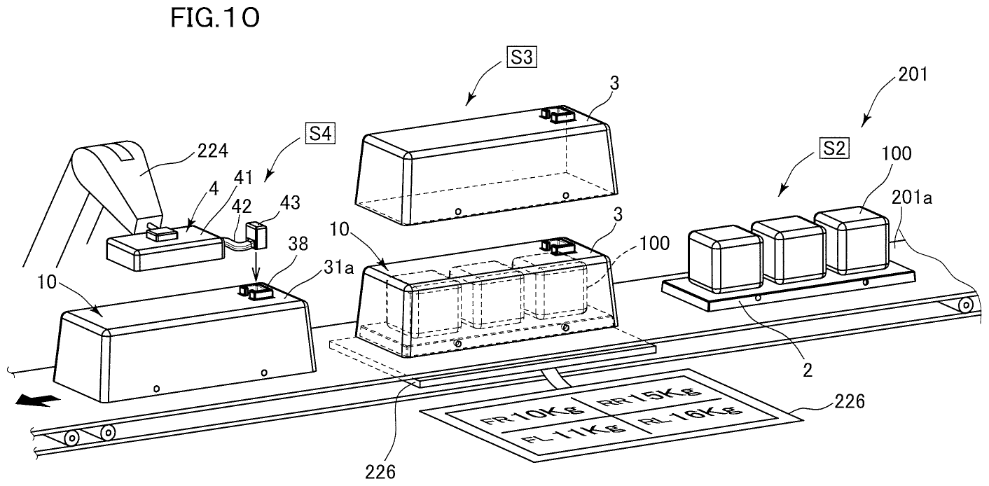

The center of gravity position acquisition portion 226 is a part for measuring the center of gravity position of the package 100 being conveyed by the package-chamber sequential-assembly line 201. The center of gravity position acquisition portion 226 is provided on an upstream side of the package-chamber sequential-assembly line 201 relative to the battery mounting device 224, as shown in FIG. 10, for example. The center of gravity position acquisition portion 226 measures a weight distribution in the horizontal direction (i.e., in-plane direction of package-chamber tray 2) of the package chamber 10 (package-chamber tray 2, package-chamber cover 3, and package 100) before the battery 4 is mounted thereto. From the weight distribution, the center of gravity position in the horizontal direction of the package chamber 10 with the package 100 housed therein is obtained, or the center of gravity position in the horizontal direction of the package 100 housed in the package chamber 10 is obtained. The center of gravity position acquisition portion 226 is formed by, for example, a pressure sensor for measuring a pressure distribution on the conveyance portion 201a, or the like.

The center of gravity position acquisition portion 226 may be provided on an upstream side of the package-chamber sequential-assembly line 201 relative to the package-chamber-cover attaching device 223, and may measure the weight distribution (center of gravity position) of the package-chamber tray 2 and the package 100 placed thereon, before the package-chamber cover 3 is attached. The center of gravity position acquisition portion 226 may acquire, in addition to the weight distribution (center of gravity position), the total weight of the package 100 placed on the package-chamber tray 2 (in a case where a plurality of packages 100 are placed, the total weight of the plurality of packages 100).

The center of gravity position acquisition portion 226 may acquire the weight of each package 100 placed on the package-chamber tray 2 and the mounting position of each package 100 on the package-chamber tray 2, and then, on the basis of the acquired weight and mounting position of each package 100, may calculate the center of gravity position of the package 100 placed on the package-chamber tray 2 (in a case where a plurality of packages 100 are placed, the center of gravity position of the entirety of the plurality of packages 100). In this case, the weight of each package 100 may be acquired through measurement at the time of calculation for the center of gravity position, or may be recorded in advance in the recording device 231. The mounting position of each package 100 may be acquired from the package mounting device 222 for placing the package 100 on the package-chamber tray 2, or may be acquired using a sensor such as a camera.

Returning to FIG. 9, the package-chamber separation device 227 is provided at the body line 203 in FIG. 8, and is a device (robot) for separating the package chamber 10 and the body 5 from the returned aerial vehicle 1.

The battery retrieval device 228 is provided at the package-chamber retrieval line 204, and is a device (robot) for taking down (retrieving) the battery 4 from the package chamber 10 which is being conveyed on the package-chamber retrieval line 204 and to which the battery 4 is mounted.

The package-chamber-cover retrieval device 229 is provided on a downstream side of the package-chamber retrieval line 204 relative to the battery retrieval device 228. The package-chamber-cover retrieval device 229 is a device (robot) for taking down (retrieving) the package-chamber cover 3 from the package chamber 10 being conveyed on the package-chamber retrieval line 204.

The package-chamber-tray retrieval device 230 is provided on a downstream side of the package-chamber retrieval line 204 relative to the package-chamber-cover retrieval device 229. The package-chamber-tray retrieval device 230 is a device (robot) for retrieving the package-chamber tray 2 being conveyed on the package-chamber retrieval line 204.

The recording device 231 is a nonvolatile recording device for recording various information therein. Specifically, the recording device 231 records therein package information about the package 100 to be transported, for example. The package information includes, for example, package identification information (such as ID number) for identifying each package 100, information indicating the weight of each package 100, information (e.g., address) indicating the transportation destination of each package 100, information indicating the transportation distance of each package 100, information indicating the storage position of each package 100 in the package storage portion 210, and the like. The package identification information and other pieces of information (such as weight, transportation destination, transportation distance, and storage position) are recorded in association with each other in the recording device 231.

In addition, the recording device 231 records therein battery information about each battery 4 stored in the battery storage portion 212, for example. The battery information includes, for example, battery identification information (such as ID number) for identifying each battery 4, information indicating the capacity of the battery 4, information indicating the charge state of the battery 4, information indicating the weight of the battery 4, information indicating the storage position of each battery 4 in the battery storage portion 212, and the like. The battery identification information and other pieces of information (such as capacity, charge state, weight, and storage position) are recorded in association with each other in the recording device 231. In general, the capacity and the weight of the battery 4 correlate with each other, i.e., as the capacity increases, the weight increases.

The control device 232 is a device for controlling the devices 221 to 230 shown in FIG. 9. For example, when the battery 4 is sufficiently charged by the battery charging portion 211, the control device 232 updates the charge state recorded in association with the identification information of the battery 4 in the recording device 231, to “charged”.

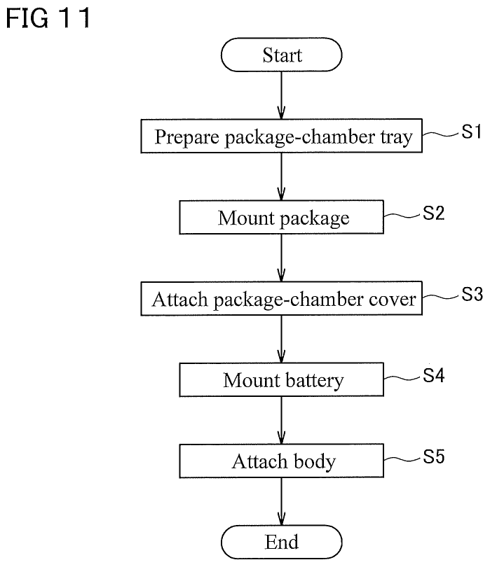

Next, a mounting method for the aerial vehicle 1 performed at the base 200 (a method for mounting the package chamber 10 at which the package 100 and the battery 4 are placed, to the body 5) will be described. FIG. 11 shows a flowchart of the mounting method. In FIGS. 8 and 10, reference characters (S1 to S5) for respective steps in FIG. 11 are shown at locations where the respective steps are performed.

First, an empty package-chamber tray 2 is placed on the conveyance portion 201a of the package-chamber sequential-assembly line 201 (S1). Specifically, the package-chamber-tray placing device 221 in FIG. 9, for example, grasps the empty package-chamber tray 2 stored in the package-chamber-tray storage portion 214 and places the package-chamber tray 2 on the conveyance portion 201a. The conveyance portion 204a of the package-chamber retrieval line 204 and the conveyance portion 201a of the package-chamber sequential-assembly line 201 may be connected and the package-chamber tray 2 being conveyed on the conveyance portion 204a of the package-chamber retrieval line 204 may be directly conveyed to the package-chamber sequential-assembly line 201.

Next, one or a plurality of packages 100 are placed on the package-chamber tray 2 placed on the conveyance portion 201a in step S1 (S2). Specifically, the package mounting device 222 in FIG. 9 selects the package 100 to be transported at this time from the packages 100 stored in the package storage portion 210, grasps the selected package 100, and places the package 100 on the package-chamber tray 2. At this time, for example, the control device 232 in FIG. 9 selects a plurality of packages 100 (pieces of package identification information thereof) having neighboring transportation destinations, by referring to the package information recorded in the recording device 231. Then, for each selected package 100, the control device 232 refers to the storage position recorded in the recording device 231 in association with the package identification information. Then, the control device 232 causes the package mounting device 222 to select the package 100 corresponding to the storage position recorded in the recording device 231 from the package storage portion 210 and place the selected package 100 on the package-chamber tray 2.

In a case of placing a plurality of packages 100 on the package-chamber tray 2, the package mounting device 222 may arrange the plurality of packages 100 in the in-plane direction of the package-chamber tray 2 (horizontal direction) (e.g., front-rear direction of package-chamber tray 2). Steps S1 and S2 correspond to a package mounting step in this disclosure.

Next, the package-chamber cover 3 is attached, from above, to the package-chamber tray 2 with the packages 100 placed thereon in step S2, so that the package-chamber tray 2 and the package-chamber cover 3 are integrated (S3). Specifically, the package-chamber-cover attaching device 223 in FIG. 9 grasps the package-chamber cover 3 stored in the package-chamber-cover storage portion 213 and attaches the package-chamber cover 3 to the package-chamber tray 2 being conveyed on the conveyance portion 201a. At this time, the package-chamber-cover attaching device 223 engages the attachment portions 23 of the package-chamber tray 2 and the attachment portions 36 of the package-chamber cover 3 with each other (see FIG. 5) so that the package-chamber cover 3 does not come off the package-chamber tray 2. Through steps S1 to S3, the package chamber 10 with the packages 100 housed therein is obtained. Step S3 corresponds to a first integration step.

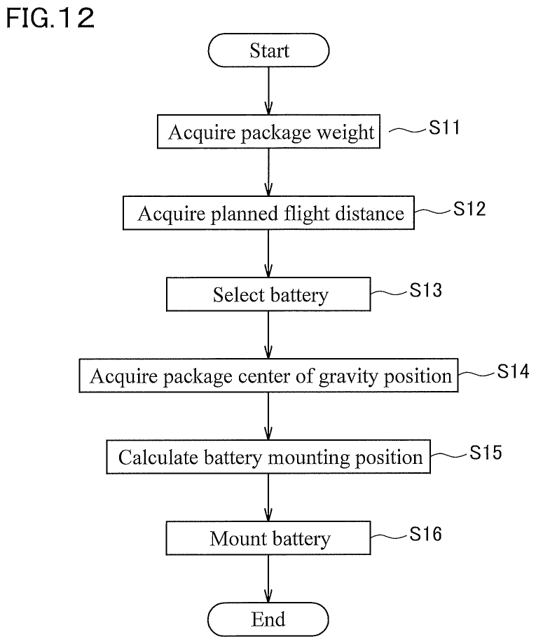

Next, the battery 4 is mounted on the upper surface of the package chamber 10 obtained in step S3 (S4). At this time, the mounting position of the battery 4 is changed in accordance with the center of gravity position of the package chamber 10 with the packages 100 housed therein before the battery 4 is mounted. Specifically, in step S4, for example, a process in FIG. 12 is executed. The process in FIG. 12 is executed by the control device 232 in FIG. 9, for example. In FIG. 12, first, the control device 232 acquires the weight of each package 100 housed in the package chamber 10 obtained in step S3 (S11). Specifically, the weight of each package 100 may be acquired from the recording device 231 in FIG. 9, for example. The weight of each package 100 may be acquired through communication from a central management device (not shown).

Next, the control device 232 acquires a planned flight distance for the aerial vehicle 1 (S12). Specifically, as the planned flight distance, the control device 232 acquires a total transportation distance from when the aerial vehicle 1 departs the base 200 until the aerial vehicle 1 transports each package 100 to the transportation destination and then returns to the base 200, for example. More specifically, the control device 232 reads the transportation destination and the transportation distance corresponding to each package 100 housed in the package chamber 10, from the recording device 231. Then, the control device 232 calculates the total transportation distance on the basis of the read transportation destination and transportation distance. At this time, in a case where the transportation destinations of the packages 10 housed in the package chamber 10 are different from each other (case of passing a plurality of locations (waypoints) until return from departure), the total transportation distance is calculated on the basis of the longest one of the transportation distances of the packages 10. The planned flight distance (total transportation distance) may be acquired through communication from the central management device (not shown).

Next, the control device 232 selects the battery 4 to be mounted to the package chamber 10 (S13). Specifically, on the basis of the weight of each package 10 acquired in step S11 and the planned flight distance acquired in step S12, the control device 232 selects, from the plurality of batteries 4 stored in the battery storage portion 212, the battery 4 having such a capacity that allows flight without charging of the battery 4 or replacement with another battery 4 until return from departure from the base 200, for example. At this time, the control device 232 selects the battery 4 having a larger capacity as the total weight of the packages 10 increases. In addition, the control device 232 selects the battery 4 having a larger capacity as the planned flight distance increases. In addition, for example, in the recording device 231 or a memory in the control device 232, the correspondence relationship between the capacity of the battery 4, and the total weight of the packages 10 and the planned flight distance, is recorded, and the control device 232 specifies the minimum necessary battery capacity for transportation at this time on the basis of the correspondence relationship, the total weight of the packages 10 and the planned flight distance acquired in steps S11 and S12. Then, the control device 232 selects the battery 4 having a capacity not smaller than the specified minimum necessary capacity. At this time, the control device 232 may select the one having the smallest capacity among the batteries 4 having capacities not smaller than the minimum necessary capacity. The above corresponding relationship may be acquired through communication from the central management device (not shown).

The control device 232 may select the battery 4 that has been charged (e.g., fully charged (100% charged)) on the basis of information indicating the charge state in the battery information recorded in the recording device 231.

The control device 232 may select the battery 4 in consideration of another condition (present weather, wind speed, manufacturing date of battery 4, etc.) in addition to the weight of the package 100 and the planned flight distance. For example, when the present weather is rain, power consumption of the battery 4 might increase due to rain resistance. Therefore, when the present weather is rain, the battery 4 having a larger capacity than in a case of sunny weather may be selected. In addition, for example, as the wind speed increases, power consumption of the battery 4 might increase. Therefore, the battery 4 having a larger capacity may be selected as the wind speed increases. In addition, for example, as the manufacturing date of the battery 4 becomes older, power consumption of the battery 4 might increase. Therefore, the battery 4 having a larger capacity may be selected as the manufacturing date of the battery 4 becomes older. Acquisition of the weight of each package 100, acquisition of the planned flight distance, and selection of the battery 4 to be mounted, in steps S11 to S13, may be performed by the central management device (not shown). In this case, the control device 232 may acquire information of the battery 4 selected by the central management device, through communication.

Next, the control device 232 causes the center of gravity position acquisition portion 226 in FIG. 9 to measure or calculate the center of gravity position (weight distribution) of the entirety of the packages 100 housed in the package chamber 10 obtained through steps S1 to S3, thus acquiring the center of gravity position (S14). The control device 232 may acquire the center of gravity position of the entirety of the package chamber 10 with the packages 100 housed therein, as the center of gravity position of the packages 100.

Next, the control device 232 calculates an optimum mounting position of the battery 4 on the upper surface of the package chamber 10 (package-chamber cover 3), on the basis of the weight of the battery 4 selected in step S13 and the center of gravity position of the packages 100 acquired in step S14 (S15). At this time, the control device 232 calculates such a mounting position of the battery 4 that the center of gravity position in the horizontal direction of the package chamber 10 after the battery 4 is mounted on the upper surface of the package chamber 10 becomes a predetermined target center of gravity position, for example. As the mounting position of the battery 4, for example, the center position or the center of gravity position of the battery body 41 on the upper surface of the package chamber 10 is calculated. The target center of gravity position is set at the center of the package chamber 10, for example.

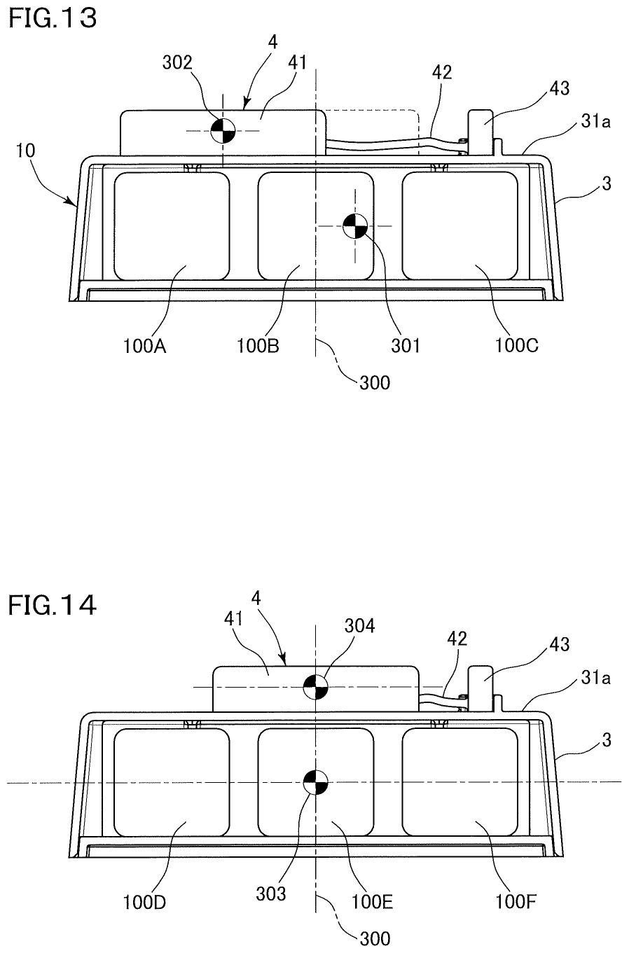

For example, in FIG. 13, three packages 100A, 100B, 100C are housed in the package chamber 10, the order of weights of the packages 100A, 100B, 100C is package 100A, package 100B, package 100C from lightest to heaviest, and the packages are arranged at equal intervals in the front-rear direction in the order of package 100A, package 100B, package 100C. A center of gravity position denoted by a reference character “301” is the package center of gravity position acquired in step S14, and a position denoted by a reference character “300” is the target center of gravity position in the front-rear direction. A position denoted by a reference character “302” is the mounting position of the battery 4 calculated in step S15 (i.e., the center position or the center of gravity position of the battery 4). In this case, since the package 100C is heavier than the package 100A, the package center of gravity position 301 is shifted toward the package 100C from the target center of gravity position 300. The mounting position 302 of the battery 4 is set at a position shifted toward the package 100A from the target center of gravity position 300. At this time, as the shift amount of the package center of gravity position 301 from the target center of gravity position 300 increases, the shift amount of the mounting position 302 of the battery 4 from the target center of gravity position 300 also increases. As the weight of the battery 4 increases, the mounting position 302 of the battery 4 may be set at a position closer to the target center of gravity position 300. As the package weight applied at the package center of gravity position 301 increases, the mounting position 302 of the battery 4 may be set at a position farther from the target center of gravity position 300.

As another example, in FIG. 14, three packages 100D, 100E, 100F are housed in the package chamber 10, the weights of the packages 100D, 100E, 100F are equal to each other, and the packages are arranged at equal intervals in the front-rear direction in the order of package 100D, package 100E, package 100F. A center of gravity position denoted by a reference character “303” is the package center of gravity position acquired in step S14, and a position denoted by a reference character “300” is the target center of gravity position in the front-rear direction. A position denoted by a reference character “304” is the mounting position of the battery 4 calculated in step S15 (i.e., the center position or the center of gravity position of the battery 4). In this case, since the weights of the packages 100D, 100E, 100F are equal to each other, the package center of gravity position 303 becomes close to the target center of gravity position 300. Accordingly, the mounting position 304 of the battery 4 also becomes close to the target center of gravity position 300.

FIGS. 13 and 14 have shown the examples in which the battery-mounting positions 302, 304 are changed in the front-rear direction among horizontal directions, in accordance with the weight of the battery 4 and the package center of gravity positions 301, 303. In a case where each package center of gravity position 301, 303 is shifted in the left-right direction from the target center of gravity position 300, the battery-mounting position 302, 304 is also shifted in the left-right direction from the target center of gravity position 300.

Here, the center of gravity position (weight distribution) acquired in step S14 changes in accordance with the weight of each package 100 placed on the package-chamber tray 2 and the mounting position of each package 100 on the package-chamber tray 2. Therefore, the optimum mounting position acquired in step S15 changes in accordance with the weight of each package 100 placed on the package-chamber tray 2, the mounting position of each package 100 on the package-chamber tray 2, and the weight of the battery 4. That is, the processing in step S15 is the same as processing of calculating the optimum mounting position of the battery 4 on the basis of the weight of each package 100 placed on the package-chamber tray 2, the mounting position of each package 100 on the package-chamber tray 2, and the weight of the battery 4.

Returning to FIG. 12, next, the control device 232 causes the battery mounting device 224 in FIG. 9 to grasp the battery 4 selected in step S13 from the battery storage portion 212 (S16). Then, the control device 232 causes the battery mounting device 224 to mount the battery body 41 of the grasped battery 4 at the battery-mounting position calculated in step S15, on the upper surface of the package chamber 10 (S16). Specifically, the battery 4 is placed on the upper surface of the package chamber 10 such that the center position or the center of gravity position of the battery body 41 coincides with the battery-mounting position calculated in step S15. Which position in the battery storage portion 212 the battery 4 selected in step S13 is stored can be found by referring to information indicating the storage position in the battery information recorded in the recording device 231.

The battery mounting device 224 mounts the battery body 41 of the battery 4 on the upper surface of the package chamber 10 and causes the connector 43 of the battery 4 to be held by the connector holder 38 (see FIG. 10). Step S4 in FIG. 11 is executed as described above. Step S4 and the process in FIG. 12 (steps S11 to S16) correspond to a battery mounting step, a center of gravity adjustment step, and a battery position adjustment step.

Through the above steps S1 to S4, the package chamber 10 with the packages 100 and the battery 4 mounted thereto is obtained. The package chamber 10 is sent from the conveyance portion 201a of the package-chamber sequential-assembly line 201 to the conveyance portion 202a of the shipping line 202. This package chamber 10 is conveyed to the merging position with the body line 203 by the conveyance portion 202a. Then, at the merging position, the body 5 sent from the body line 203 is attached to the package chamber 10 from above, whereby the package chamber 10 and the body 5 are integrated (step S5 in FIG. 11). Specifically, the body attaching device 225 in FIG. 9 grasps the body 5 sent from the conveyance portion 203a of the body line 203 or the body 5 stored in the body storage portion 215 (see FIG. 8), and attaches the body 5 to the package chamber 10. At this time, the body attaching device 225 engages the attachment portions 37 of the package-chamber cover 3 and the attachment portions 57 of the body cover 51 with each other (see FIG. 5) so that the package-chamber cover 3 (package chamber 10) does not come off the body 5.

In step S5, when the package chamber 10 and the body 5 are attached to each other, the connector 43 of the battery 4 and the connector 59 on the body 5 side are automatically connected. Thus, it becomes possible to supply power to the body 5. Step S5 corresponds to a second integration step.

Through steps S1 to S5 in FIG. 11, the aerial vehicle 1 to which the package chamber 10, the packages 100, and the battery 4 are mounted, is completed. Thereafter, the aerial vehicle 1 is sent to a departure position on a further downstream side by the conveyance portion 202a of the shipping line 202, and starts to fly toward the transportation destination.

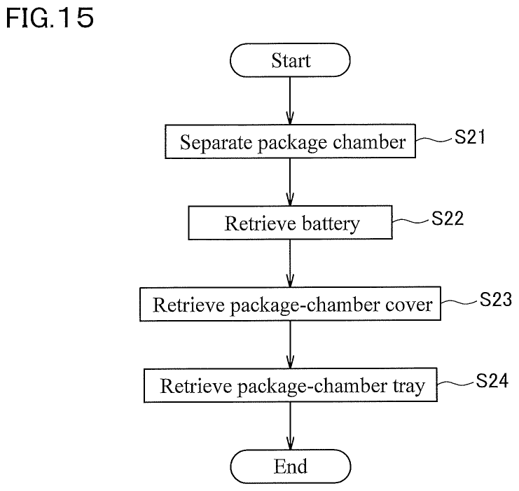

Next, a method for separating the aerial vehicle 1 into the parts 2, 3, 4, 5, performed at the base 200, will be described. FIG. 15 shows a flowchart of the separation method. In FIG. 8, reference characters (S21 to S24) for respective steps in FIG. 15 are shown at locations where the respective steps are performed.

First, the aerial vehicle 1 having returned to the base 200 is received to the body line 203. Then, the package chamber 10 is separated from the aerial vehicle 1 (S21). Specifically, the package-chamber separation device 227 in FIG. 9 releases engagement between the attachment portions 37 of the package-chamber cover 3 and the attachment portions 57 of the body cover 51 of the aerial vehicle 1, and pulls the body 5 upward of the package chamber 10 or pulls the package chamber 10 downward of the body 5, thereby separating the body 5 and the package chamber 10 to which the battery 4 is mounted. Then, the package-chamber separation device 227 lets the separated body 5 be still conveyed on the conveyance portion 203a of the body line 203 or moves the separated body 5 to the body storage portion 215. Further, the package-chamber separation device 227 places the separated package chamber 10 (including battery 4) on the conveyance portion 204a of the package-chamber retrieval line 204.

Next, in step S21, the battery 4 is retrieved from the package chamber 10 placed on the conveyance portion 204a (S22). Specifically, the battery retrieval device 228 in FIG. 9 grasps the battery 4 placed on the package chamber 10, and sends the battery 4 to the battery storage portion 212 or the battery charging portion 211. The package chamber 10 after the battery 4 has been retrieved is conveyed downstream by the conveyance portion 204a.

Next, the package-chamber cover 3 is retrieved from the package chamber 10 being conveyed on the conveyance portion 204a after battery retrieval (S23). Specifically, the package-chamber-cover retrieval device 229 in FIG. 9 releases engagement between the attachment portions 36 of the package-chamber cover 3 and the attachment portions 23 of the package-chamber tray 2, and pulls the package-chamber cover 3 upward of the package-chamber tray 2 or pulls the package-chamber tray 2 downward of the package-chamber cover 3, thereby separating the package-chamber cover 3 and the package-chamber tray 2. Then, the package-chamber-cover retrieval device 229 moves the separated package-chamber cover 3 to the package-chamber-cover storage portion 213. The package-chamber tray 2 remains placed on the conveyance portion 204a.

Next, the package-chamber tray 2 being conveyed on the conveyance portion 204a is retrieved (S24). Specifically, the package-chamber-tray retrieval device 230 in FIG. 9 grasps the package-chamber tray 2 placed on the conveyance portion 204a, and sends the package-chamber tray 2 to the package-chamber-tray storage portion 214 or the conveyance portion 201a of the package-chamber sequential-assembly line 201.

Hereinafter, effects of the first embodiment will be described. Since the package chamber 10 is attachable and detachable to and from the body 5 of the aerial vehicle 1, the package chamber 10 with the package 100 and the battery 4 mounted thereto can be prepared in advance (can be initially set up) before preparation of the body 5. Thus, when the body 5 has been prepared, the package 100 and the battery 4 can be immediately mounted to the body 5, whereby the mounting work time can be shortened. In addition, the package 100 and the battery 4 can be mounted to the body 5 at the same time. Since the package chamber 10 with the battery 4 and the package 100 mounted thereto can be initially set up, operation management for the aerial vehicle 1 at the base 200 is facilitated, and for example, the body 5 having returned to the base 200 can be immediately integrated with the next package chamber 10 so as to fly. Thus, the aerial vehicles 1 (body 5) can take off sequentially without waiting time, whereby the turnover (operation rate) of the body 5 can be increased.

The package-chamber tray 2 (placement portion for package 100) of the package chamber 10 can be separated from the package-chamber cover 3. Therefore, in a state of being separated from the package-chamber cover 3, the package 100 can be placed on the package-chamber tray 2 and the package 100 placed on the package-chamber tray 2 can be taken down. Thus, loading and unloading of the package 100 can be efficiently performed. In addition, such a package-chamber structure that it is easy for a robot to automatically perform loading and unloading of the package 100, can be provided. Further, separating the package-chamber tray 2 from the package-chamber cover 3 makes it easy to place a plurality of packages 100 on the package-chamber tray 2 and also makes it easy to adjust the mounting position of the package 100 on the package-chamber tray 2.

The package-chamber cover 3 is attached to the package-chamber tray 2 from above and is separated upward of the package-chamber tray 2. Therefore, it is easy for a robot to automatically perform attachment and detachment of the package-chamber cover 3 to and from the package-chamber tray 2.

Since the package-chamber space 35 of the package chamber 10 is a space closed on all sides, the package 100 can be protected from rain (water) and the like. In addition, since the package chamber 10 does not have an opening/closing portion on a side other than the lower side, rain water can be prevented from entering the package-chamber space 35 through a gap of the opening/closing portion of the package chamber 10.

The tray body 21 of the package-chamber tray 2 in a state of being attached to the package-chamber cover 3 is located on the inner side of the package-chamber space 35 relative to the downward opening 34 of the package-chamber cover 3 (see FIGS. 2 and 3). Therefore, the package 100 placed on the tray body 21 can be further protected from rain and the like. Further, in a state in which the package-chamber tray 2 is attached to the package-chamber cover 3, the entire periphery of the outer-periphery portion 22 of the package-chamber tray 2 contacts with the inner surface 32a of the side-surface portion 32 of the package-chamber cover 3, that is, the outer side of the outer-periphery portion 22 is covered by the side-surface portion 32. Therefore, the package 100 placed on the tray body 21 can be further protected from rain and the like.

Since the package chamber 10 in a state of being attached to the body 5 is housed in the space 55 of the body cover 51, the package 100 housed in the package chamber 10 can be further protected from rain and the like. Since the body space 55 is closed on the sides other than the lower side, rain falling from above can be prevented from entering the body space 55.

The body 5 is attached to the package chamber 10 from above and is separated upward of the package chamber 10. Therefore, it is easy for a robot to automatically perform attachment and detachment of the body 5 to and from the package chamber 10.

The parts 2, 3, 4, 5 constituting the aerial vehicle 1 are structured as nested boxes integrated by being sequentially attached from above. Therefore, the integration work is easy and waterproof property against rain can be obtained.

The battery 4 is mounted on the upper surface of the package chamber 10. Therefore, in a state in which the package chamber 10 is separated from the body 5, mounting of the battery 4 can be performed and retrieval of the battery 4 from the package chamber 10 can be performed. Thus, mounting and retrieval of the battery 4 can be facilitated.

The battery 4 is selected in consideration of the weight of the package 100 housed in the package chamber 10 and the planned flight distance. Therefore, the battery 4 can be prevented from being charged or replaced during transportation. Thus, the body 5 of the aerial vehicle 1 can be efficiently used. In addition, the battery 4 having a greater weight (higher capacity) than necessary can be prevented from being mounted. Thus, flight can be prevented from becoming unstable due to the weight of the battery 4, and fuel consumption (power consumption of battery 4) during flight can be reduced owing to weight reduction, leading to increase in the flight distance.

The mounting position of the battery 4 on the package chamber 10 can be adjusted in accordance with the center of gravity position of the package chamber 10 with the package 100 housed therein. Therefore, the center of gravity position of the aerial vehicle 1 can be set at an optimum position, whereby flight can be stabilized. In addition, since flight is stabilized, the rotary blades 53 can be prevented from unnecessarily rotating for orientation control of the aerial vehicle 1, whereby fuel consumption during flight can be reduced, leading to increase in the flight distance. Since the aerial vehicle 1 does not have a mechanism (electric portion such as servomotor) for adjusting the mounting position of the battery 4, the structure of the aerial vehicle 1 can be simplified and the weight of the aerial vehicle 1 can be reduced. Further, since the mounting position of the battery 4 is adjusted in initial setup before the body 5 and the package chamber 10 are integrated, the center of gravity position of the entire aerial vehicle 1 when the package chamber 10 with the package 100 and the battery 4 mounted thereto is integrated with the body 5 can be determined in the initial setup. Thus, center of gravity adjustment for the aerial vehicle 1 can be efficiently performed.

In a state of being mounted to the body 5, the battery 4 is housed in the space 58 between the upper surface of the package chamber 10 and the wall surface of the body space 55, whereby the battery 4 can be protected from rain and the like.

Since the connector holder 38 provided to the package-chamber cover 3 is located at a position opposed to the connector 59 provided to the body 5, the connector 43 of the battery 4 and the connector 59 of the body 5 can be automatically connected when the package chamber 10 and the body 5 are integrated.

### Second Embodiment

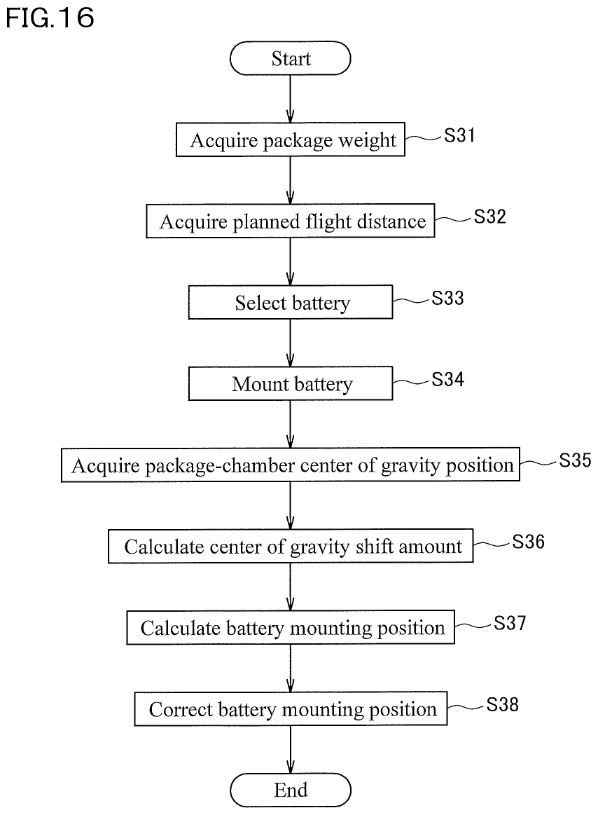

Next, a second embodiment of this disclosure will be described focusing on difference from the first embodiment. The first embodiment has shown the example in which the process in FIG. 12 is executed as step S4 in FIG. 11, whereas in this embodiment, a process in FIG. 16 is executed instead of the process in FIG. 12. The other matters are the same as in the first embodiment. Hereinafter, the process in FIG. 16 will be described.

The process in FIG. 16 is executed by the control device 232 in FIG. 9, for example. First, the control device 232 acquires the weight of each package 100 housed in the package chamber 10 (S31). Step S31 is the same as step S11 in FIG. 12. Next, the control device 232 acquires the planned flight distance (S32). Step S32 is the same as step S12 in FIG. 12. Next, the control device 232 selects the battery 4 to be mounted to the package chamber 10, on the basis of the weight and the planned flight distance acquired in steps S31 and S32 (S33). Step S33 is the same as step S13 in FIG. 12.

Next, the control device 232 commands the battery mounting device 224 in FIG. 9 to mount the battery 4 selected in step S33 on the upper surface of the package chamber 10 (S34). The battery mounting device 224 grasps the battery 4 selected in step S33, from the battery storage portion 212. Then, the battery mounting device 224 mounts the battery body 41 of the battery 4 on the upper surface of the package chamber 10 and causes the connector 43 to be held by the connector holder 38. At this time, the mounting position of the battery body 41 on the upper surface of the package chamber 10 may be a predetermined position (e.g., the center of the upper surface of the package chamber 10) irrespective of the center of gravity position of the packages 100.

Next, the control device 232 acquires the center of gravity position of the package chamber 10 in a state in which the packages 100 and the battery 4 are mounted (S35). Specifically, for example, the center of gravity position acquisition portion 226 in FIG. 9 is located at the same position as the battery mounting device 224 at the package-chamber sequential-assembly line 201 (see FIG. 8), and is configured to measure the weight distribution in the horizontal direction of the package chamber 10 in a state in which the packages 100 and the battery 4 are mounted. Then, the control device 232 may acquire, as the center of gravity position, the measurement value (weight distribution) measured by the center of gravity position acquisition portion 226. Alternatively, the control device 232 acquires the mounting position in the horizontal direction and the weight of each package 100 placed on the package-chamber tray 2 in step S2 in FIG. 11, and acquires the mounting position in the horizontal direction and the weight of the battery 4 mounted in step S34 in FIG. 16. Then, the control device 232 may acquire the center of gravity position in the horizontal direction of the entirety of the packages 100 and the battery 4 through calculation on the basis of the mounting positions and the weights of the packages 100 and the battery 4.

Next, the control device 232 calculates a shift amount of the center of gravity position acquired in step S35 from a predetermined target center of gravity position (S36). The target center of gravity position may be set at the center of the package chamber 10, for example.

Next, the control device 232 calculates such a mounting position of the battery 4 that the center of gravity position of the entire package chamber 10 becomes the target center of gravity position, on the basis of the center of gravity shift amount calculated in step S36, the weight of the battery 4, and the weights of the packages 100 (S37). As the mounting position of the battery 4, for example, the center position or the center of gravity position of the battery body 41 on the upper surface of the package chamber 10 is calculated. As the weight of the battery 4 and the weights of the packages 100, for example, values recorded in advance in the recording device 231 (see FIG. 9) may be used or the weights may be measured at the time of calculation in step S37.

Next, the control device 232 commands the battery mounting device 224 in FIG. 9 to remount the battery 4 at the mounting position calculated in step S37 (S38). That is, the mounting position of the battery 4 is corrected.

Also in this case, the same effects as in the first embodiment can be obtained. The process in FIG. 16 (steps S31 to S38) corresponds to a battery mounting step, a center of gravity adjustment step, and a battery position adjustment step.

### Third Embodiment

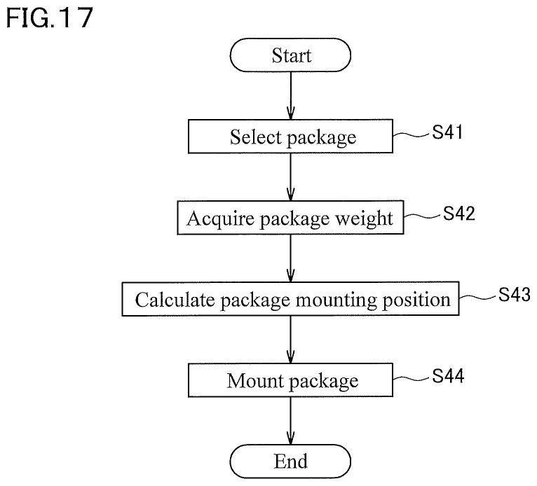

Next, a third embodiment of this disclosure will be described focusing on difference from the first and second embodiments. The first and second embodiments have shown the examples in which the mounting position of the battery 4 is adjusted in accordance with the center of gravity position of the packages 100, whereas this embodiment shows an example in which the mounting positions of the packages 100 are adjusted. Specifically, in this embodiment, a process in FIG. 17 is executed as step S2 in FIG. 11. In addition, in step S4 in FIG. 11, the battery 4 may be mounted at a predetermined position on the upper surface of the package chamber 10 without performing adjustment for the mounting position of the battery 4, or the process shown in the first or second embodiment (process in FIG. 12 or FIG. 16) may be executed. The matters other than steps S2 and S4 in FIG. 11 are the same as in the first and second embodiments. Hereinafter, the process in FIG. 17 will be described.

The process in FIG. 17 is executed by the control device 232 in FIG. 9, for example. First, the control device 232 selects one or a plurality of packages 100 to be mounted on the package-chamber tray 2 (S41). That is, the control device 232 selects the package 100 to be transported at this time from the packages 100 stored in the package storage portion 210. For example, the control device 232 may select a plurality of packages 100 having neighboring transportation destinations, by referring to the package information recorded in the recording device 231.

Next, the control device 232 acquires the weight for each package 100 selected in step S41 (S42). As the weight of the package 100, for example, a value recorded in advance in the recording device 231 (see FIG. 9) may be acquired, or a value measured by a weight measurement device may be acquired during execution of the process in FIG. 17.

Next, on the basis of the weight of each package 100 acquired in step S42, the control device 232 calculates such a mounting position (optimum mounting position) of each package 100 on the package-chamber tray 2 that the center of gravity position in the horizontal direction of the entirety of the packages 100 when the packages 100 are placed on the package-chamber tray 2 becomes a predetermined target center of gravity position (S43). The target center of gravity position may be set at the center of the package chamber 10, for example.

For example, in a case where there are two packages 100 (first and second packages) and the first package 100 and the second package 100 have the same weight, the mounting positions of the first package 100 and the second package 100 may be calculated such that the mounting position of the first package 100 is set on the front side relative to the target center of gravity position, the mounting position of the second package 100 is set on the rear side relative to the target center of gravity position, and a shift amount of the mounting position of the first package 100 from the target center of gravity position and a shift amount of the mounting position of the second package 100 from the target center of gravity position become equal to each other.

As another example, in a case where there are two packages 100 (first and second packages) and the second package 100 is heavier than the first package 100, the mounting positions of the first package 100 and the second package 100 may be calculated such that the mounting position of the first package 100 is set on the front side relative to the target center of gravity position, the mounting position of the second package 100 is set on the rear side relative to the target center of gravity position, and a shift amount of the mounting position of the second package 100 from the target center of gravity position becomes smaller than a shift amount of the mounting position of the first package 100 from the target center of gravity position. In this case, as the weight of the first package 100 decreases, the mounting position of the first package 100 may be set at a position farther from the target center of gravity position. In addition, as the weight of the second package 100 increases, the mounting position of the second package 100 may be set at a position closer to the target center of gravity position.

Next, the control device 232 commands the package mounting device 222 in FIG. 9 to mount each package 100 selected in step S41 at the mounting position calculated in step S43 on the package-chamber tray 2 (S44). Thus, the center of gravity position of the entirety of the packages 100 can be made to coincide with the target center of gravity position.

In the later step S4 in FIG. 11, the battery 4 may be mounted at a position that coincides with the center of gravity position (target center of gravity position) of the entirety of the packages 100 on the upper surface of the package chamber 10, for example. In step S4, the process in FIG. 12 or FIG. 16 described in the first or second embodiment may be executed.

The process in FIG. 17 is the example in which optimum mounting positions of the packages 100 are calculated before the packages 100 are mounted on the package-chamber tray 2, and then the packages 100 are mounted at the optimum mounting positions. Instead of the process in FIG. 17, the mounting positions of the packages 100 may be adjusted as follows.

That is, the packages 100 are placed on the package-chamber tray 2 once. Next, the center of gravity position in the horizontal direction of the entirety of the packages 100 placed on the package-chamber tray 2 is measured or calculated. Next, a shift amount between the measured or calculated center of gravity position and the target center of gravity position is calculated. Next, on the basis of the shift amount, such optimum mounting positions of the packages 100 that the center of gravity position of the entirety of the packages 100 becomes the target center of gravity position are calculated. Next, the packages 100 are remounted at the optimum mounting position.

Thus, also in this embodiment, the same effects as in the first and second embodiments can be obtained. In addition, the mounting position of the package 100 is adjusted in initial setup before the body 5 and the package chamber 10 are integrated, whereby the center of gravity position of the entire aerial vehicle 1 when the package chamber 10 with the package 100 and the battery 4 mounted thereto is integrated with the body 5 can be determined in the initial setup. Thus, center of gravity adjustment for the aerial vehicle 1 can be efficiently performed. The process in FIG. 17 (steps S41 to S44) corresponds to a center of gravity adjustment step and a package position adjustment step.

### Fourth Embodiment

Next, a fourth embodiment of this disclosure will be described focusing on difference from the first to third embodiments. The first to third embodiments have shown the examples in which the mounting position of the battery or the package is adjusted such that the center of gravity position of the package chamber is optimized, whereas this embodiment shows an example in which the mounting position of the package chamber to the body is adjusted.

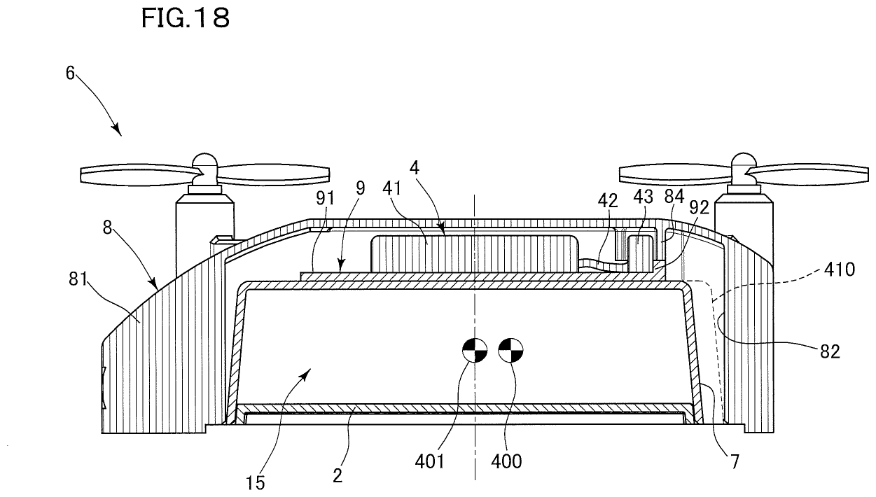

FIG. 18 shows a sectional view of an unmanned aerial vehicle according to this embodiment. In FIG. 18, the same parts as those in the first to third embodiments are denoted by the same reference characters. An aerial vehicle 6 in FIG. 18 includes the package-chamber tray 2, a package-chamber cover 7, the battery 4, and a body 8, as in the first to third embodiments. Further, the aerial vehicle 6 includes a battery tray 9.

The package-chamber tray 2 and the battery 4 are the same as the package-chamber tray 2 and the battery 4 in the first to third embodiments.

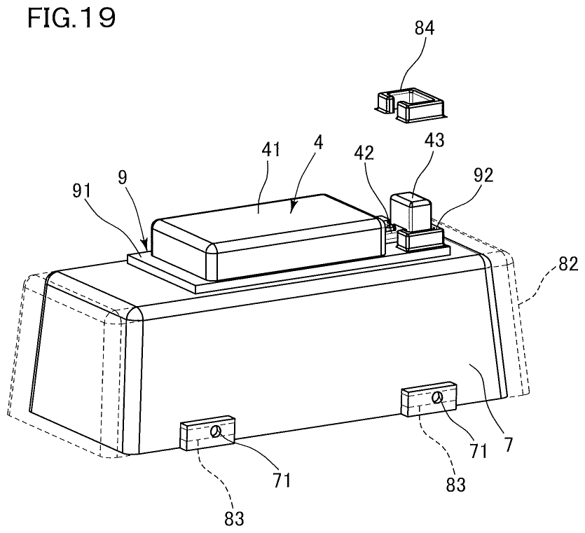

The package-chamber cover 7 is provided so as to be attachable and detachable to and from a body cover 81 of the body 8. The package-chamber cover 7 includes attachment portions 71 (see FIG. 19) to be attached to attachment portions 83 (see FIG. 19) provided to the body cover 81 when the package-chamber cover 7 is attached to the body cover 81. The attachment portions 71 are different from the attachment portions 37 (see FIGS. 4 and 5) in the first to third embodiments in that the attachment portions 71 have a function for adjusting the mounting position of the package-chamber cover 7 in a space 82 (body space) of the body cover 81, together with the attachment portions 83 of the body cover 81. Except for the attachment portions 71, the structure of the package-chamber cover 7 is the same as that of the package-chamber cover 3 in the first to third embodiments. The package-chamber tray 2 and the package-chamber cover 7 form a package chamber 15.

The body space 82 is configured to allow adjustment of the mounting position in the horizontal direction of the package-chamber cover 7. Specifically, as shown in FIGS. 18 and 19, the width in the front-rear direction (advancement direction of aerial vehicle 6) of the body space 82 is greater than the width in the front-rear direction of the package-chamber cover 7. That is, the mounting position in the front-rear direction of the package-chamber cover 7, in the body space 82, can be adjusted. In this embodiment, the width in the left-right direction of the body space 82 is the same as the width in the left-right direction of the package-chamber cover 7. However, the width in the left-right direction of the body space 82 may be set to be greater than the width in the left-right direction of the package-chamber cover 7, whereby the mounting position in the left-right direction of the package-chamber cover 7 can also be adjusted. The mounting position in the front-rear direction of the package-chamber cover 7, in the body space 82, may be unable to be adjusted, and the mounting position in the left-right direction of the package-chamber cover 7 may be able to be adjusted.

The attachment portions 83 to be attached to the attachment portions 71 of the package-chamber cover 7 are provided at wall surfaces of the body space 82 (see FIG. 19). The attachment portions 83 are different from the attachment portions 57 (see FIG. 5) in the first to third embodiments in that the attachment portions 83 have a function for adjusting the mounting position of the package-chamber cover 7 in the body space 82, together with the attachment portions 71 of the package-chamber cover 7. Except for the attachment portions 83 and the size of the body space 82, the structure of the body 8 is the same as that of the body 5 in the first to third embodiments.

The attachment portions 71, 83 serve as a mounting position adjustment portion for adjusting the mounting position of the package-chamber cover 7 in the body space 82 as described above. The attachment portions 71, 83 have a function for adjusting the mounting position in the front-rear direction of the package-chamber cover 7, in the body space 82, for example. In this case, the attachment portions 71, 83 are provided at positions opposed to each other in the left-right direction in a state in which the package-chamber cover 7 and the body cover 81 are attached to each other. Either the attachment portion 71 or the attachment portion 83 is formed in a projection shape (protrusion shape), and the other attachment portion is formed in a recess shape. By the projection shape and the recess shape being engaged with each other, the package-chamber cover 7 is held so as not to come off downward from the body cover 81. The recess shape extends in the front-rear direction (mounting position adjustment direction). By the projection shape moving in the front-rear direction in a state of being engaged with the recess shape, the mounting position in the front-rear direction of the package-chamber cover 7 is changed while the package-chamber cover 7 is held by the body cover 81.

In the example in FIG. 19, the attachment portion 71 of the package-chamber cover 7 is formed in a projection shape, and the attachment portion 83 of the body cover 81 is formed in a recess shape. However, the attachment portion 71 may be formed in a recess shape and the attachment portion 83 may be formed in a projection shape. In this embodiment, the attachment portions 71, 83 are provided at four locations in total, i.e., two locations on the front and rear sides at the left surface and two locations on the front and rear sides at the right surface. However, the attachment portions 71, 83 may be provided at any number of locations.

As in the first to third embodiments, the engagement state between the attachment portions 71, 83 is released when a predetermined release operation is performed.

The battery tray 9 is provided so as to be attachable and detachable to and from the upper surface of the package-chamber cover 7. The battery tray 9 includes a placement portion 91 on which the battery body 41 of the battery 4 is to be placed, and a connector holder 92 (holding portion) for holding the connector 43 (first connector) of the battery 4. The placement portion 91 is formed in a flat-plate shape, for example. An upper surface of the placement portion 91 is formed as a horizontal surface, and forms a placement surface for the battery body 41. The connector holder 92 is provided on the upper surface of the placement portion 91 integrally with the placement portion 91.

The shape of the connector holder 92 is the same as that of the connector holder 38 (see FIGS. 2 and 4) in the first to third embodiments.

The battery tray 9 is provided such that the mounting position thereof on the upper surface of the package-chamber cover 7 can be adjusted. Specifically, the mounting position of the battery tray 9 on the upper surface of the package-chamber cover 7 is adjusted such that, in a state in which the package-chamber cover 7 is attached to the body cover 81, the connector holder 92 is located at a position opposed to a connector 84 (second connector) provided to the body cover 81. In the state in which the package-chamber cover 7 is attached to the body cover 81, the connector 43 of the battery 4 held by the connector holder 92 is connected to the connector 84 on the body 8 side. The battery tray 9 serves as a connector position adjustment portion for adjusting the position of the connector holder 92 (i.e., connector 43 of battery 4) on the upper surface of the package chamber 15 so as to be a position opposed to the connector 84 on the body 8 side, irrespective of the mounting position of the package chamber 15 in the body 8. The connector holder 92 is configured as a connector holder of which the mounting position on the upper surface of the package chamber 15 can be adjusted.

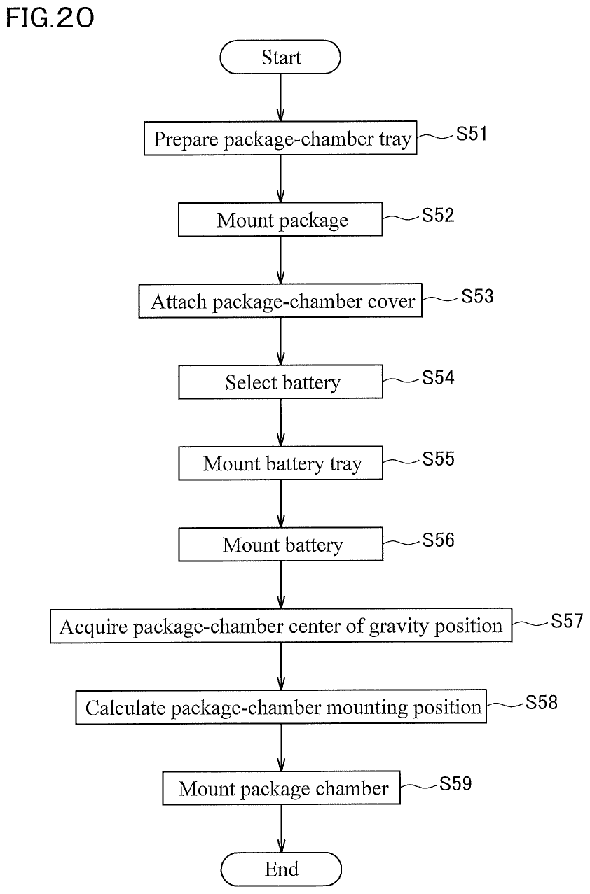

In this embodiment, mounting of the package chamber 15 (including packages and battery 4) to the aerial vehicle body 8 is performed at the base 200 shown in FIG. 8, as in the first to third embodiments, for example. The base 200 includes a battery-tray mounting device (not shown) for placing the battery tray 9 on the upper surface of the package-chamber cover 7, in addition to the configuration in FIG. 9. The battery-tray mounting device is provided to the package-chamber sequential-assembly line 201 in FIG. 8. Mounting of the package chamber 15 (including packages and battery 4) to the aerial vehicle body 8 is performed through a flowchart in FIG. 20, for example, instead of the flowchart in FIG. 11. Hereinafter, a mounting method shown in FIG. 20 will be described.

First, an empty package-chamber tray 2 is prepared (S51). Step S51 is the same as step S1 in FIG. 11. Next, each package is placed on the package-chamber tray 2 prepared in step S51 (S52). Step S52 is the same as step S2 in FIG. 11. Next, the package-chamber cover 7 is attached to the package-chamber tray 2 with the packages placed thereon (S53). Step S53 is the same as step S3 in FIG. 11.

Next, the battery 4 to be mounted on the upper surface of the package-chamber cover 7 (package chamber 15) is selected (S54). Step S54 is executed by the control device 232 in FIG. 9, for example. In step S54, as in steps S11 to S13 in FIG. 12, the weights of the packages and the planned flight distance are acquired, and the battery 4 having a necessary capacity for transportation at this time is selected on the basis of the package weights and the planned flight distance.

Next, by the battery-tray mounting device (not shown), the battery tray 9 is placed on the upper surface of the package-chamber cover 7 attached in step S53 (S55).

Next, by the battery mounting device 224 (see FIG. 9), the battery 4 selected in step S54 is placed on the battery tray 9 mounted in step S55 (S56). At this time, the battery mounting device 224 causes the connector 43 of the battery 4 to be held by the connector holder 92.

Next, the center of gravity position in the horizontal direction of the entire package chamber 15 with the battery 4 and the packages mounted therein is acquired (S57). Specifically, for example, the center of gravity position acquisition portion 226 in FIG. 9 is configured to measure the weight distribution in the horizontal direction of the package chamber 15 in a state in which the packages and the battery 4 are mounted. Then, the control device 232 in FIG. 9 may acquire, as the center of gravity position, the measurement value (weight distribution) measured by the center of gravity position acquisition portion 226. Alternatively, the control device 232 acquires the mounting position in the horizontal direction and the weight of each package placed on the package-chamber tray 2 in step S52 in FIG. 20, and acquires the mounting position in the horizontal direction and the weight of the battery 4 mounted in step S56. Then, the control device 232 may acquire the center of gravity position in the horizontal direction of the entire package chamber 15 through calculation on the basis of the mounting positions and the weights of the packages and the battery 4.

Next, the control device 232 calculates an optimum mounting position of the package chamber 15 in the body space 82 on the basis of the center of gravity position acquired in step S57 (S58). Specifically, for example, such a mounting position of the package chamber 15 in the body space 82 that the center of gravity position acquired in step S57 coincides with a predetermined target center of gravity position in the body space 82, is calculated as the optimum mounting position.

For example, in FIG. 18, the center of gravity position acquired in step S57 is a position denoted by a reference character “401”. The target center of gravity position is a position denoted by a reference character “400”. In this case, such a package-chamber mounting position 410 that the center of gravity position 401 coincides with the target center of gravity position 400 is calculated as the optimum mounting position.

Here, the center of gravity position (weight distribution) acquired in step S57 changes in accordance with the weight of each package placed on the package-chamber tray 2, the mounting position of each package on the package-chamber tray 2, the weight of the battery 4 mounted to the package chamber 15, and the mounting position of the battery 4 on the upper surface of the package chamber 15. Therefore, the optimum mounting position acquired in step S58 changes in accordance with the weight of each package placed on the package-chamber tray 2, the mounting position of each package on the package-chamber tray 2, the weight of the battery 4, and the mounting position of the battery 4. That is, the processing in step S58 is the same as processing of calculating the optimum mounting position of the package chamber 15 on the basis of the weight of each package, the mounting position of each package, the weight of the battery 4, and the mounting position of the battery 4.

Next, the control device 232 causes the body attaching device 225 in FIG. 9 to attach the body 8 from above the package chamber 15, thereby integrating the body 8 and the package chamber 15 to which the battery 4 and the package are mounted (S59). At this time, the package chamber 15 is mounted to the body 8 such that the mounting position of the package chamber 15 in the body space 82 becomes the optimum mounting position calculated in step S58. In addition, in a case of adjusting the mounting position of the package chamber 15 in the body space 82, the mounting position of the battery tray 9 on the upper surface of the package chamber 15 (i.e., the mounting position of the battery body 41 on the battery tray 9) is adjusted such that the connector holder 92 (connector 43 of battery 4) comes to a position opposed to the connector 84 on the body 8 side while a relative positional relationship between the battery body 41 and the package chamber 15 is kept being a positional relationship when the battery 4 is mounted to the package chamber 15 in step S56. Thus, irrespective of the mounting position of the package chamber 15 in the body space 82, the connector 43 of the battery 4 and the connector 84 on the body 8 side can be connected.

As described above, in this embodiment, the mounting position of the package chamber 15 in the body 8 is adjusted in accordance with the center of gravity position of the package chamber 15 at which the battery 4 and the packages are placed, whereby the center of gravity position of the aerial vehicle 6 can be set at an optimum position. Thus, the same effects as in the first to third embodiments can be obtained. That is, flight of the aerial vehicle 6 can be stabilized and the flight distance can be increased.

Steps S51 and S52 in FIG. 20 correspond to a package mounting step. Step S53 corresponds to a first integration step. Steps S54 to S56 correspond to a battery mounting step. Steps S57 to S59 correspond to a second integration step, a center of gravity adjustment step, and a package chamber position adjustment step.

This disclosure is not limited to the above embodiments and may be modified variously. For example, in the above embodiments, all the steps for mounting the package and the battery to the unmanned aerial vehicle and all the steps for separating parts (package-chamber tray, package-chamber cover, body, battery) of the unmanned aerial vehicle are automatically performed by a robot. However, at least one of the steps may be performed by a human. That is, for example, a human may perform mounting of the package on the package-chamber tray, a human may perform attachment and detachment between the package-chamber tray and the package-chamber cover, a human may perform loading and unloading of the battery to and from the package-chamber upper surface, and a human may perform attachment and detachment between the package chamber and the body. In the first and second embodiments, a human may perform adjustment of the battery-mounting position on the package-chamber upper surface. In this case, for example, the optimum mounting position obtained through steps S11 to S15 in FIG. 12 or steps S31 to S37 in FIG. 16 may be outputted by means such as display on a display device, and a human may perform mounting of the battery 4 on the basis of the outputted optimum mounting position.

In the third embodiment, a human may perform adjustment of the mounting position of the package on the package-chamber tray. In this case, the optimum mounting position obtained through steps S41 to S43 in FIG. 17 may be outputted by means such as display on a display device, and a human may perform mounting of the package on the package-chamber tray on the basis of the outputted optimum mounting position. In the fourth embodiment, a human may perform adjustment of the mounting position of the package chamber in the body. In this case, the optimum mounting position obtained in step S58 in FIG. 20 may be outputted by means such as display on a display device, and a human may perform mounting of the package chamber to the body on the basis of the outputted optimum mounting position. A human may perform selection of the package to be placed on the package-chamber tray. Also, a human may perform selection of the battery to be mounted to the package chamber.

In the above embodiments, the body cover of the unmanned aerial vehicle is formed in a box shape having an opening on the lower side. However, the body of the unmanned aerial vehicle may have any shape that allows attachment and detachment to and from the package chamber and can ensure a waterproof structure for the battery placed on the package chamber.

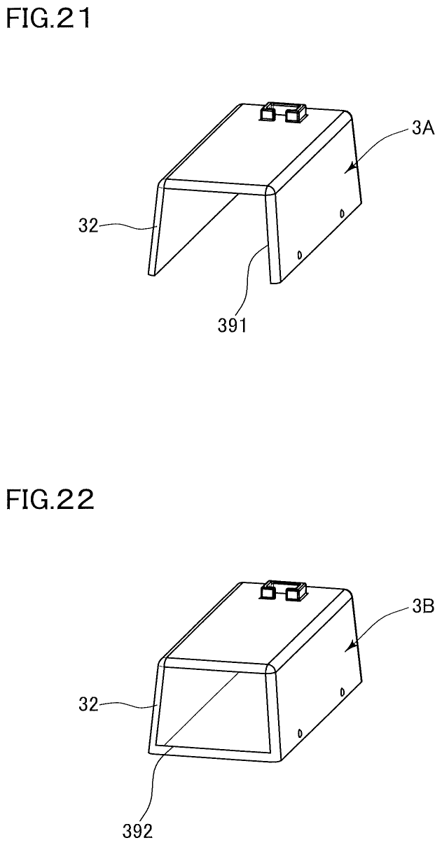

In the above embodiments, the package-chamber tray is attached to the package-chamber cover from below and is detached downward from the package-chamber cover. However, without limitation thereto, for example, as shown in FIGS. 21 and 22, a side-surface opening 391, 392 communicating with an internal space (package-chamber space) of a package-chamber cover 3A, 3B is provided at a side-surface portion 32 of a package-chamber cover 3A, 3B. Then, through the side-surface opening 391, 392, a package-chamber tray and a package placed thereon may be slid from a lateral side (sideways), to attach the package-chamber tray to the package-chamber cover 3A, 3B, and may be slid to the lateral side (sideways), to detach the package-chamber tray from the package-chamber cover 3A, 3B. The side-surface opening 391 shown in FIG. 21 is a cutout formed by cutting out a lower end of the package-chamber cover 3A. That is, the side-surface opening 391 is formed in a shape opened on the lower side. The side-surface opening 392 shown in FIG. 22 is a hole formed with a distance provided from the lower end of the package-chamber cover 3B. That is, the side-surface opening 392 is formed in a shape closed on the lower side. The package-chamber cover 3A, 3B is formed in the same manner as the package-chamber cover 3 in the first embodiment or the package-chamber cover 7 in the fourth embodiment except that the side-surface opening 391, 392 is formed on the lateral side (side-surface portion 32). In FIGS. 21 and 22, the side-surface opening 391, 392 is formed at the side-surface portion 32 on the front side of the package-chamber cover 3A, 3B, but may be formed at the side-surface portion 32 on the left, right, or rear side. The package-chamber cover 3A, 3B may have a lid for closing the side-surface opening 391, 392. Thus, in a state in which the lid is opened (the side-surface opening 391, 392 is exposed), the package-chamber tray is attached and detached to and from the package-chamber cover 3A, 3B through the side-surface opening 391, 392, and by closing the lid in a state in which the package-chamber tray is attached to the package-chamber cover 3A, 3B, a foreign material such as water can be prevented from entering the inside of the package chamber from the lateral side. The package-chamber cover 3A, 3B may have a bottom-surface portion closing the internal space. Thus, a foreign material such as water can be further prevented from entering the inside of the package-chamber cover 3A, 3B from below.

In the fourth embodiment, the battery body is placed above the package-chamber upper surface with the battery tray interposed therebetween. However, as long as the mounting position of the connector holder for holding the connector of the battery on the package-chamber upper surface can be adjusted, the battery body may be directly mounted on the package-chamber upper surface. That is, in FIG. 19, of the battery tray 9, the part 91 on which the battery body 41 is to be placed may not be provided.

### DESCRIPTION OF THE REFERENCE CHARACTERS

1, 6 unmanned aerial vehicle
2 package-chamber tray
3, 7 package-chamber cover
4 battery
5, 8 body of unmanned aerial vehicle
10, 15 package chamber
100 package

What is claimed is:

1. An unmanned aerial vehicle comprising:
a placement portion on which a package is to be placed;
a package-chamber cover which is attached to the placement portion so as to cover the package placed on the placement portion and is provided separably from the placement portion;
a battery provided on an upper surface of the package-chamber cover and configured to drive an unmanned aerial vehicle; and
a body capable of flying, the body being attachable and detachable to and from a package chamber formed by including the placement portion and the package-chamber cover.

2. The unmanned aerial vehicle according to claim 1, wherein
a mounting position of the battery is adjustable within the upper surface.

3. The unmanned aerial vehicle according to claim 1, wherein
the upper surface of the package-chamber cover has a holding portion configured to hold a first connector which is a connector of the battery,
the body has a second connector which is a connector configured to receive power supply to the body, and
the holding portion is provided at such a position that the first connector and the second connector are connected when the package chamber with the battery mounted thereto is attached to the body.

4. The unmanned aerial vehicle according to claim 1, wherein
the package-chamber cover forms a package-chamber space having an opening on a lower side or a lateral side, and
the placement portion is located on an inner side of the package-chamber space relative to the opening in a state in which the package-chamber cover is attached to the placement portion.

5. The unmanned aerial vehicle according to claim 1, wherein
the body forms a body space having an opening on a lower side,
the package chamber is attached to the body such that the package chamber is housed in the body space, and
the body forms a battery-housing space between an upper surface of the package chamber provided in the body space and a wall surface of the body space.

6. The unmanned aerial vehicle according to claim 1, wherein
the body and the package chamber include a mounting position adjustment portion configured to adjust a mounting position of the package chamber relative to the body.

7. A method for mounting a package to the unmanned aerial vehicle according to claim 1, the method comprising:
a package mounting step of placing the package on the placement portion;
a first integration step of integrating the package-chamber cover and the placement portion on which the package is placed, after the package mounting step;
a battery mounting step of placing the battery on the upper surface of the package chamber in which the package is housed, after the first integration step; and
a second integration step of integrating the body and the package chamber in which the package is housed and on the upper surface of which the battery is placed, after the battery mounting step.

8. The unmanned aerial vehicle mounting method according to claim 7, further comprising a center of gravity adjustment step of adjusting a center of gravity position of the unmanned aerial vehicle before flight of the unmanned aerial vehicle.

9. The unmanned aerial vehicle mounting method according to claim 8, wherein
the center of gravity adjustment step includes a battery position adjustment step of adjusting a mounting position of the battery on the upper surface of the package chamber.

10. The unmanned aerial vehicle mounting method according to claim 8, wherein
the center of gravity adjustment step includes a package position adjustment step of adjusting a mounting position of the package on the placement portion.

11. The unmanned aerial vehicle mounting method according to claim 8, wherein
the center of gravity adjustment step includes a package chamber position adjustment step of adjusting a mounting position, in the body, of the package chamber at which the package and the battery are placed.

12. An unmanned aerial vehicle center of gravity adjustment method for adjusting a center of gravity position of the unmanned aerial vehicle according to claim 1, the method comprising
adjusting, before flight of the unmanned aerial vehicle,
a mounting position of the battery on the upper surface of the package chamber,
a mounting position of the package on the placement portion, or
a mounting position, in the body, of the package chamber at which the battery is placed.
